(19) United States
(12) Patent Application Publication
(10) Pub. No.: US 2013/0063793 A1
(43) Pub. Date: Mar. 14, 2013

(54) AUTOMATIC DOCUMENT FEEDER, IMAGE FORMING APPARATUS, AND METHOD OF DIVIDING SHEET

(71) Applicant: Katsunori Suzuki, Shizuoka-ken (JP)

(72) Inventor: Katsunori Suzuki, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/600,430

(22) Filed: Aug. 31, 2012

Related U.S. Application Data
(60) Provisional application No. 61/532,235, filed on Sep. 8, 2011.
(60) Provisional application No. 61/532,165, filed on Sep. 8, 2011.

(51) Int. Cl. H04N 1/04

(52) U.S. Cl. 358/498; 358/1.13

(57) ABSTRACT

According to an embodiment, an automatic document feeder includes a supply tray, a transport path, a plurality of flappers, a plurality of discharge trays, and an erasing unit. The plurality of flappers divides a sheet which is transported from the supply tray toward the plurality of transport destinations. The plurality of discharge trays receives the sheet which is divided and transported in the transport path. The erasing unit is provided between the supply tray and the predetermined reading position in the transport path, and erases color of an image which is formed on a transported sheet using a decolorable colorant.

CROSS-REFERENCE TO RELATED APPLICATION(S)

This application is based upon and claims the benefit of priority from: U.S. provisional application 61/532235, filed on Sep. 8, 2011; and U.S. provisional application 61/532165, filed on Sep. 8, 2011; the entire contents all of which are incorporated herein by reference.

### FIELD

Embodiments disclosed herein generally relate to a technology of dividing a document in a technology of automatically transporting the document in which a plurality of sheet documents is continuously transported toward a predetermined image reading position.

### BACKGROUND

In the related art, an automatic document feeder (Auto Document Feeder) which continuously transports a plurality of sheet documents which is placed in a supply tray is known.

However, in the above described automatic document feeder in the related art, even though it is able to simply automatically transport the plurality of sheet documents which is placed in the supply tray, it is unable to divide and transport the plurality of sheet documents based on some predetermined determination conditions or the like.

### DESCRIPTION OF THE DRAWINGS

FIG. 1 is a schematic vertical cross-sectional view which illustrates a configuration example of an image forming apparatus which includes an automatic document feeder according to an embodiment.

FIG. 2 is a functional block diagram which describes the image forming apparatus according to the embodiment.

FIG. 3 is a diagram which illustrates a sheet transporting state in the image forming apparatus.

FIG. 4 is a diagram which illustrates a sheet transporting state in the image forming apparatus.

FIG. 5 is a diagram which illustrates a sheet transporting state in the image forming apparatus.

FIG. 6 is a diagram which illustrates a sheet transporting state in the image forming apparatus.

FIG. 7 is a diagram which illustrates a sheet transporting state in the image forming apparatus.

FIG. 8 is a diagram which illustrates a sheet transporting state in the image forming apparatus.

FIG. 9 is a diagram which illustrates a sheet transporting state in the image forming apparatus.

FIG. 10 is a diagram which illustrates a sheet transporting state in the image forming apparatus.

FIG. 11 is a diagram which illustrates a sheet transporting state in the image forming apparatus.

FIG. 12 is a diagram which illustrates a sheet transporting state in the image forming apparatus.

FIG. 13 is a diagram which illustrates a sheet transporting state in the image forming apparatus.

FIG. 14 is a diagram which illustrates a sheet transporting state in the image forming apparatus.

FIG. 15 is a diagram which illustrates a sheet transporting state in the image forming apparatus.

FIG. 16 is a diagram which illustrates a sheet transporting state in the image forming apparatus.

FIG. 17 is a diagram which illustrates a sheet transporting state in the image forming apparatus.

FIG. 18 is a diagram which illustrates a sheet transporting state in the image forming apparatus.

FIG. 19 is a diagram which illustrates a sheet transporting state in the image forming apparatus.

FIG. 20 is a diagram which illustrates a sheet transporting state in the image forming apparatus.

FIG. 21 is a diagram which illustrates a sheet transporting state in the image forming apparatus.

FIG. 22 is a diagram which illustrates a sheet transporting state in the image forming apparatus.

FIG. 23 is a diagram which illustrates a sheet transporting state in the image forming apparatus.

FIG. 24 is a diagram which illustrates a sheet transporting state in the image forming apparatus.

FIG. 25 is a diagram which illustrates a sheet transporting state in the image forming apparatus.

FIG. 26 is a diagram which illustrates a sheet transporting state in the image forming apparatus.

FIG. 27 is a diagram which illustrates a sheet transporting state in the image forming apparatus.

FIG. 28 is a diagram which illustrates a sheet transporting state in the image forming apparatus.

FIG. 29 is a diagram which illustrates a sheet transporting state in the image forming apparatus.

FIG. 30 is a diagram which illustrates a sheet transporting state in the image forming apparatus.

FIG. 31 is a diagram which illustrates a sheet transporting state in the image forming apparatus.

FIG. 32 is a diagram which illustrates a sheet transporting state in the image forming apparatus.

FIG. 33 is a diagram which illustrates a sheet transporting state in the image forming apparatus.

FIG. 34 is a diagram which illustrates a sheet transporting state in the image forming apparatus.

FIG. 35 is a flowchart which describes an example of a processing flow (sheet dividing method) in the image forming apparatus.

FIG. 36 is a diagram which exemplifies content of counting of the number of sheets in a tray which is displayed.

FIG. 37 is a flowchart which shows a flow of a sheet dividing process by an automatic document feeder only.

FIG. 38 is a diagram which exemplifies the content of counting of the number of sheets in the tray which is displayed.

### DETAILED DESCRIPTION

In general, according to an embodiment, an automatic document feeder includes a supply tray, transport paths, a plurality of flappers, a plurality of discharge trays, and an erasing unit. The supply tray loads sheets as transporting targets. The transport path guides the sheets which are loaded in the supply tray to a predetermined plurality of transport destinations, respectively, passing through a predetermined reading position at which an image on the sheet is read. The plurality of flappers divides the sheets which are transported from the supply tray toward the plurality of transport destinations. The plurality of discharge trays receives the sheets which are divided and transported in the transport paths. The erasing unit is provided between the supply tray in the transport path and a predetermined reading position, and erases color of an image which is formed on a transported sheet using a decolorable colorant.

Hereinafter, the embodiment will be described with reference to drawings.

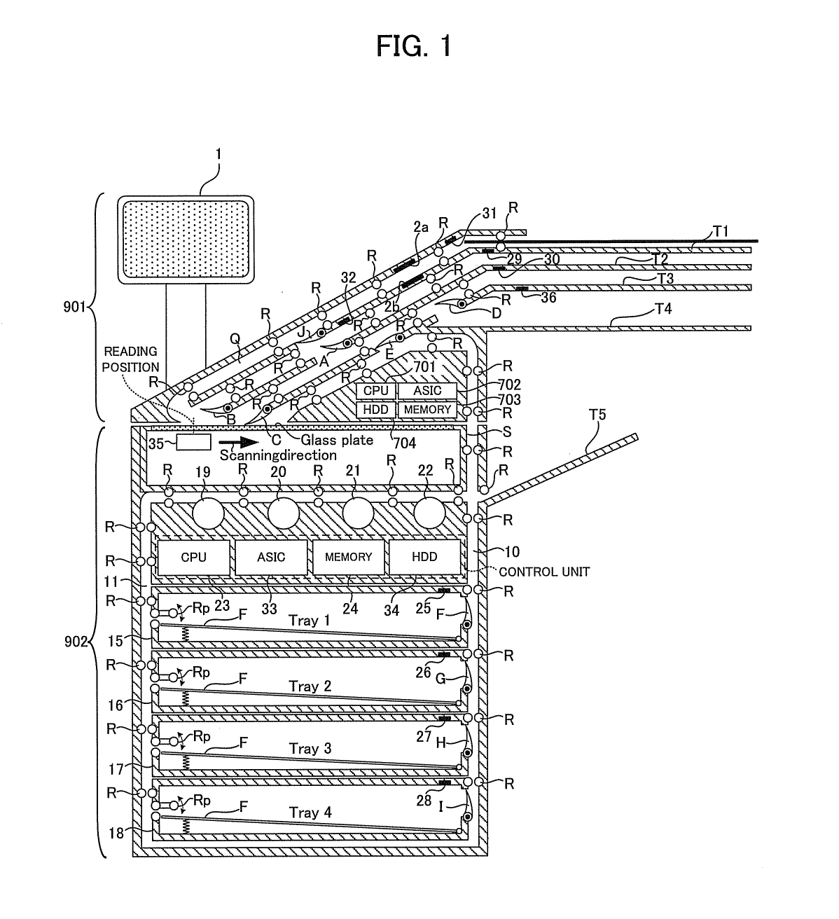

FIG. 1 is a schematic vertical cross-sectional view which illustrates an example of a configuration of an image forming apparatus including an automatic document feeder according to the embodiment.

The image forming apparatus (Multi Function Peripheral) according to the embodiment includes an automatic document feeder 901, and a main body of image forming apparatus 902.

The automatic document feeder 901 is installed onto the main body of image forming apparatus 902 in an openable manner.

Hereinafter, a configuration of the image forming apparatus according to the embodiment will be described in detail.

The automatic document feeder 901 includes, for example, a CPU (Central Processing Unit) 701, an ASIC (Application Specific Integrated Circuit) 702, a MEMORY 703, an HDD (Hard Disk Drive) 704, a touch panel display 1, a supply tray T1, a transport path Q, a plurality of flappers A, B, C, D, E, and J on the ADF side, a plurality of discharge trays T2 to T4, erasing units 2a and 2b, and passage sensors 29, 30, 31, 32, and 36.

Hereinafter, each constituent element included in the automatic document feeder 901 will be described.

The supply tray T1 loads sheets as transporting targets.

The transport path Q guides the sheets which are loaded in the supply tray T1 to a predetermined plurality of transport destinations, respectively, passing through a predetermined reading position at which an image on the sheet is read.

The plurality of flappers A, B, C, D, E, and J on the ADF side divides the sheets which are transported from the supply tray T1 toward the predetermined plurality of transport destinations. Driving of the plurality of flappers A, B, C, D, E, and J on the ADF side is controlled, for example, by the CPU 701, or a CPU 23.

The plurality of discharge trays T2 to T4 receive the sheets which are divided and transported in the transport path Q. According to the embodiment, a case where the number of discharge trays is three is exemplified, however, the discharge trays which are included in the automatic document feeder 901 may be at least two, and for example, the number of discharge trays may be four or more.

The erasing units 2a and 2b are provided between the supply tray T1 and a predetermined reading position in the transport path Q, and erases color of an image which is formed on the transported sheet using a decolorable colorant.

In addition, the erasing units 2a and 2b here are for erasing color of an image which is formed using the decolorable colorant, for example, using heat, and are provided on the transport path which is located at the uppermost part of the automatic document feeder 901 in the transport path Q.

By arranging the erasing units 2a and 2b at a position which is closest to the outside air on the upper part of the device in this manner, it becomes easy to discharge heat generated in the erasing units 2a and 2b to the outside of the units.

In addition, here, the erasing units 2a and 2b are arranged to face each other so as to interpose the transport path Q therebetween. In this manner, even when images are formed using the decolorable colorant on both sides of a sheet, it is possible to efficiently erase the images on both sides of the sheet. It is natural that the erasing units 2a and 2b may be provided at different positions from each other in the sheet transport direction, if it is possible to perform an appropriate erasing processing with respect to both sides of the sheet.

In addition, the decolorable colorant here includes coloring materials which are able to form an image as a product on a sheet, such as toner, or ink, and whose color used in an image can be erased using some kind of means, for example, by heating, irradiating UV light or the like, applying a chemical solution, physical chipping off, or the like.

In this manner, according to the embodiment, the automatic document feeder 901 which is able to transport a sheet document on which an image is read at a predetermined reading position to a plurality of sheet discharge trays includes the erasing units 2a and 2b which erase color of an image which is formed using the decolorable colorant.

In this manner, it is possible to divide and transport sheets to any of the discharge trays T2 to T4 therein based on a scanning result by performing the erasing process in the automatic document feeder 901, and by performing scanning an erased state of the sheet after the erasing processing.

In addition, according to the embodiment, the plurality of discharge trays T2 to T4 are arranged at the lower part of the supply tray T1. It is natural that at least any of the discharge trays T2 to T4 may be located at the lower part of the supply tray T1, without placing all of the discharge trays T2 to T4 at the lower part of the supply tray Ti.

In this manner, it is possible to improve an efficiency of a space of the automatic document feeder 901 as a whole (in particular, efficiency of a space in the plane direction) by arranging the plurality of discharge trays as respective discharge destinations of the sheets to be divided and transported at the lower part of the supply tray.

It is possible to adopt a well known variety of sensors for detecting passing through of the sheet document as the passage sensors 29, 30, 31, and 32. For example, it is possible to adopt a transmissive optical sensor, a reflection-type optical sensor, a mechanical passage sensor using a lever, or the like. Detection signals in the passage sensors 29, 30, 31, and 32 are obtained, for example, using the CPU 701, or the CPU 23. The detection signal in the passage sensors 29 to 32 which are obtained using the CPU 701, or the CPU 23 are stored, for example, in MEMORY 24 and MEMORY 703, HDDs 34 and 704, or the like.

In addition, it is possible to use the passage sensor 32 when performing switchback transport of the sheet.

A display screen of the touch panel display 1 may be configured by, for example, electronic paper, an LCD (Liquid crystal display), an EL (Electronic Luminescence), a PDP (Plasma Display Panel), a CRT (Cathode Ray Tube), or the like. In addition, it is also possible to execute the same function as that of the touch panel display 1 from an operation input unit, such as a keyboard, a mouse, a touch panel, a touchpad, a pen tablet (graphics tablet), a dedicated button, or the like, and a display screen.

The main body of image forming apparatus 902 includes, for example, the CPU 23, the ASIC 33, the MEMORY 24, the HDD 34, and an image reading unit S including a reading head 35, photoconductive drums 19 to 22, a plurality of supply trays 15 to 18 on the main body side, a discharge tray T5, transport paths 10 and 11 on the main body side, a plurality of transport rollers R, a plurality of flappers F, G, H, and I on the main body side.

Hereinafter, each constituent element included in the main body of image forming apparatus 902 will be described in detail.

The image reading unit S reads out an image on a document (for example, a sheet document or a book document) which is loaded on a glass plate by scanning the reading head 35 in the scanning direction shown in FIG. 1.

In addition, when reading out a sheet which is transported by the automatic document feeder 901, an image on the sheet which is automatically transported to a reading position by the automatic document feeder 901 is read using the reading head 35 which is stopped at a predetermined reading position (home position) shown in FIG. 1.

The plurality of supply trays 15 to 18 on the main body side supplies a sheet to have an image formed thereon to a printing unit which forms an image on the sheet. Specifically, the plurality of supply trays 15 to 18 includes, for example, a pickup roller Rp, a lift-up plate F which is elastically supported using a spring, and carrying-in detection sensors 25 to 28. A control of a feeding operation using the pickup roller Rp is performed, for example, using the CPU 701, or the CPU 23.

The carrying-in detection sensors 25 to 28 detect the number of sheets carried in to the respective plurality of supply trays on the main body side. As the carrying-in detection sensors 25 to 28, it is possible to adopt a well-known variety of sensors for detecting passing through of the sheet document. For example, it is possible to adopt the transmissive optical sensor, the reflection-type optical sensor, the mechanical passage sensor using the lever, or the like. The detection signals in the carrying-in detection sensors 25 to 28 are obtained, for example, using the CPU 701, or the CPU 23. The detection signal in the carrying-in detection sensors 25 to 28 which are obtained using the CPU 701, or the CPU 23 are stored, for example, in the MEMORY 24 and MEMORY 703, the HDDs 34 and 704, or the like.

Transport paths 10 and 11 on the main body side guide sheets which are transported from the automatic document feeder 901 to the plurality of supply trays on the main body side, respectively.

The plurality of transport rollers R takes a role as means for transporting which transports the sheets in the transport paths 10 and 11 on the main body side.

The plurality of flappers F, G, H, and I on the main body side divides the sheets which are transported from the automatic document feeder 901 toward the plurality of supply trays on the main body side, respectively. Driving of the flappers F, G, H, and I on the main body side is controlled using, for example, the CPU 701, or the CPU 23.

In addition, the plurality of transport rollers R is rotatably driven, respectively, by a motor which is not shown. In addition, driving of the motor which is not shown is controlled, for example, by the CPU 701, or the CPU 23.

In the image forming apparatus according to the embodiment, the CPU 701 and the CPU 23 take a role of performing various processing in the entire image forming apparatus, and take a role of executing various functions by executing a program which is stored in the MEMORY 24 and MEMORY 703, the HDDs 34 and 704, or the like. In addition, it is natural that the CPUs 701 and 23 can also be executed using an MPU (Micro Processing Unit) which can execute the same arithmetic processing as those of the CPUs 701 and 23. In addition, similarly, the HDDs 34 and 704 can be replaced by storage units, for example, a flash memory, or the like.

The MEMORY 24 and MEMORY 703 can be configured by, for example, a RAM (Random Access Memory), ROM (Read Only Memory), DRAM (Dynamic Random Access Memory), SRAM (Static Random Access Memory), VRAM (Video RAN), a flash memory, or the like, and take a role of storing various pieces of information or programs which are used in the entire image forming apparatus.

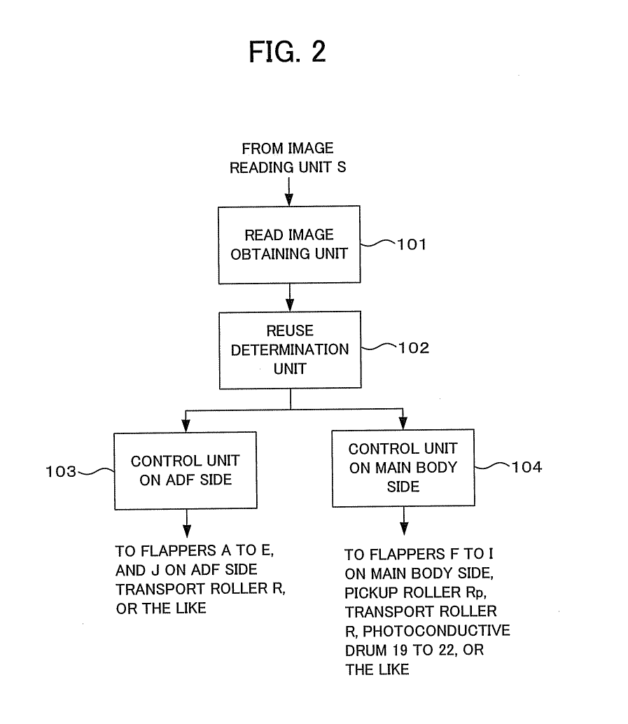

FIG. 2 is a functional block diagram which describes the image forming apparatus according to the embodiment.

The image forming apparatus according to the embodiment includes functions of, for example, a read image obtaining unit 101, a reuse determination unit 102, a control unit 103 on ADF side, a control unit 104 on the main body side, or the like. These functions can be performed by executing a program stored in the MEMORY 24, MEMORY 703, and the HDDs 34 and 704, or the like, using the CPUs 701 and 23, and it is also possible to execute a part, or all of these functions using the ASICs 702 and 33.

The read image obtaining unit 101 obtains image data which is read from a sheet at a predetermined reading position.

The reuse determination unit 102 determines whether or not a sheet on which an image is read is reusable based on the image data which is obtained in the read image obtaining unit 101. Specifically, the reuse determination unit 102 determines a possibility of reuse of the sheet as a printing medium on the basis of determination standards, for example, a density (whether or not a predetermined density is exceeded), an area (whether or not a predetermined area is exceeded), a contrast (whether or not there is a portion exceeding a predetermined contrast level), a shape, a position (whether or not the image is located at a position interfering with image forming, such as the center of the sheet), or the like, of the image which remains on the sheet not being erased.

The control unit 103 on ADF side controls the plurality of flappers so that the sheet on which the image is read is guided to a discharge tray which is correlated in advance in the determination result among the plurality of discharge trays T2 to T4 based on the determination result of the reuse determination unit 102.

The control unit 103 on ADF side controls the plurality of flappers so that the sheet is guided to any of the plurality of discharge trays T2 to T4, when all of the supply trays 15 to 18 on main body side which are correlated with the determination result of the sheet reach the number of sheets allowed to be accommodated.

The control unit 103 on ADF side controls the plurality of flappers so that a sheet determined to be a reusable sheet is guided to any of the plurality of discharge trays T2 to T4.

The control unit 103 on ADF side controls the plurality of flappers so that a sheet determined to be a non-reusable sheet is guided to any of the plurality of discharge trays T2 to T4.

The control unit 104 on the main body side counts the number of sheets which is accommodated in the plurality of supply trays on the main body side, respectively, based on the detection result using a carrying-in detection sensor, and the number of sheets carried out from the plurality of supply trays on the main body side. For example, the CPU 701 sets the reusable sheet to the supply tray T1 on the ADF side of the automatic document feeder 901, and adds one to the number of remaining sheets in the tray based on the detection result of the sensor which is provided at the respective trays, when the reusable sheet is transported to any of the supply trays on the main body side, or to the discharge tray on the ADF side after erasing the color of the image on the sheet using the erasing units 2a and 2b, after feeding the sheet.

In this manner, it is possible for a user to appropriately operate the sheet by displaying the number of sheets which is accommodated in the supply trays on the main body side in practice, respectively. In addition, the user is informed that a tray is in a full state by providing warning, or error indication on the display 1 when the tray in which the maximum accommodation number or more of sheets are already accommodated.

The control unit 104 on the main body side controls the plurality of flappers on the main body side so that sheets are guided to other trays which are correlated with a determination result determined in advance, among the plurality of discharge trays and the plurality of supply trays on the main body side, when a count value of the accommodation number of sheets in a tray as the sheet transport destination reach the number of sheets allowed to be accommodated which is set in the tray.

In addition, according to the embodiment, the discharge trays T2 to T4 on the ADF side, and the plurality of supply trays 15 to 18 on the main body side are assigned with any of attributes,

(1) Tray for normal sheet

(2) Tray for reusable sheet

(3) Tray for sheet to be discarded

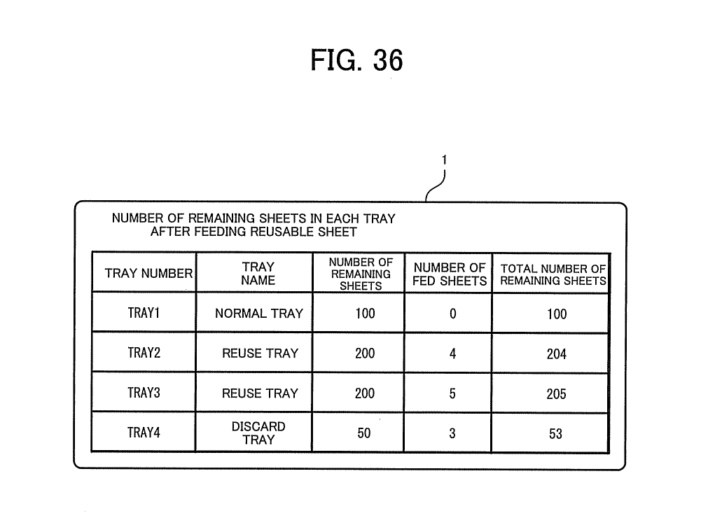

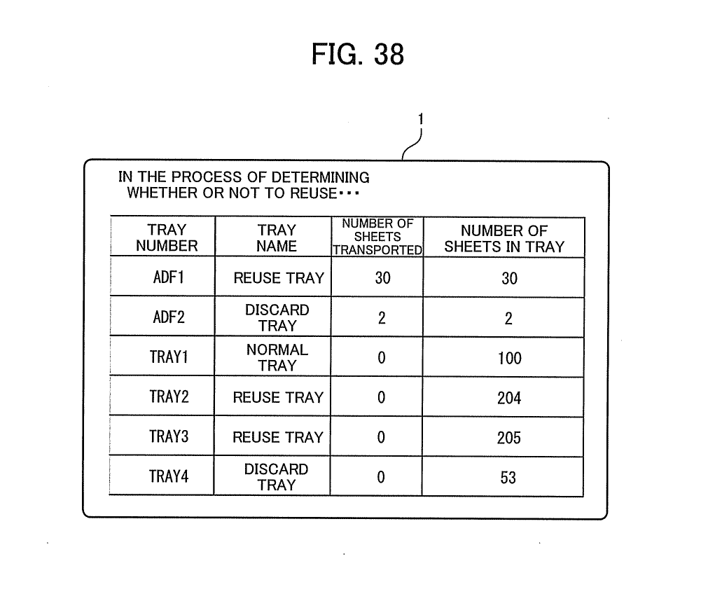

in advance, respectively, and the assigned set contents are stored in the MEMORY 24 and MEMORY 703, HDDs 34 and 704, or the like (refer to FIGS. 36 and 38). The image forming apparatus switches a transport destination of the sheet based on the set contents of each tray.

Subsequently, the sheet transport operation in the image forming apparatus according to the embodiment will be described in detail while referring to drawings. In the following description, for convenience of description, a case where the CPU 701 performs various controls in the image forming apparatus is exemplified, however, without being limited to the case, the CPU 23 may take in charge of various controls in the image forming apparatus, and it is also possible for the CPUs 701 and 23 to execute the various controls in collaboration with each other.

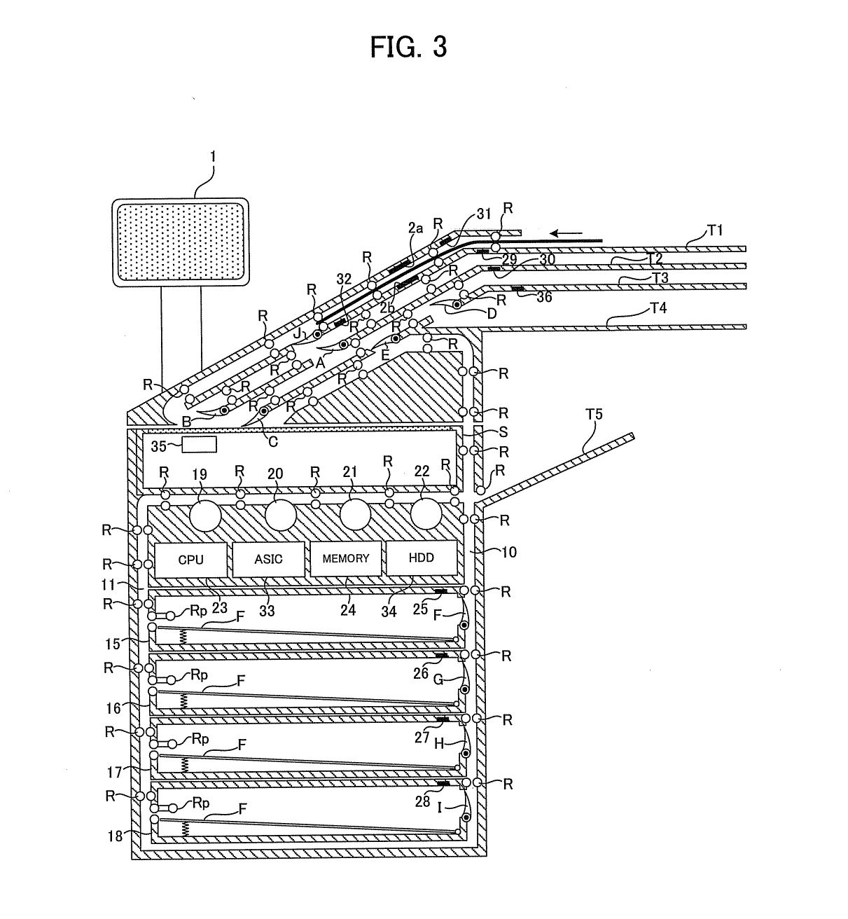

FIGS. 3 to 34 are diagrams which illustrate the sheet transport state in the image forming apparatus.

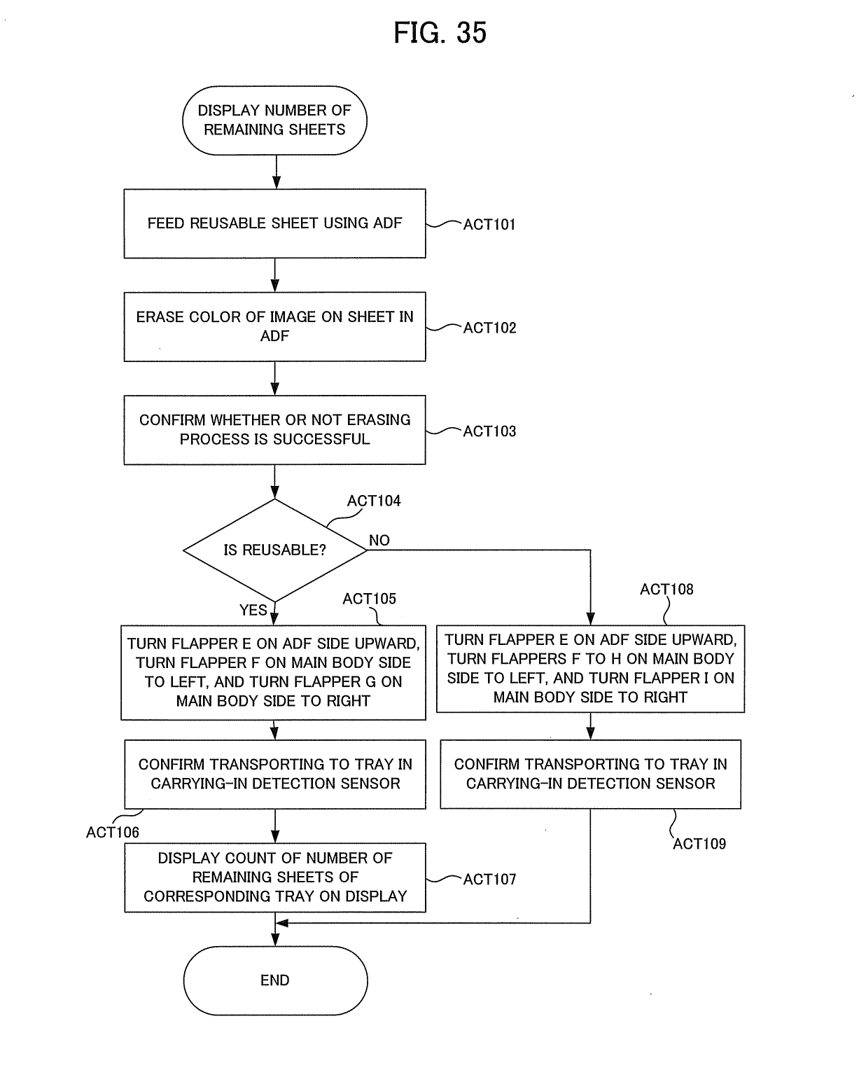

FIG. 35 is a flowchart which describes an example of a flow of processing in the image forming apparatus (method of dividing sheets).

First, a user sets a sheet to be reused in the supply tray T1 which is provided at an inlet of the transport path Q of the automatic document feeder 901 (a state shown in FIG. 1).

Subsequently, the CPU 701 starts transporting of the sheet which is set in the supply tray T1 using the transport roller R when an operation input of starting of reuse processing by a user is received in the touch panel display 1 (ACT 101) .

The CPU 701 heats the sheet which is started to be transported using the erasing units 2a and 2b which are provided in the vicinity of the inlet of the transport path Q, and erases color of an image which is formed using a decolorable colorant (ACT 102) (a state shown in FIG. 3) . It is also possible to proceed to determination processing in the latter stage without performing the heating process using the erasing units 2a and 2b, by performing setting in advance.

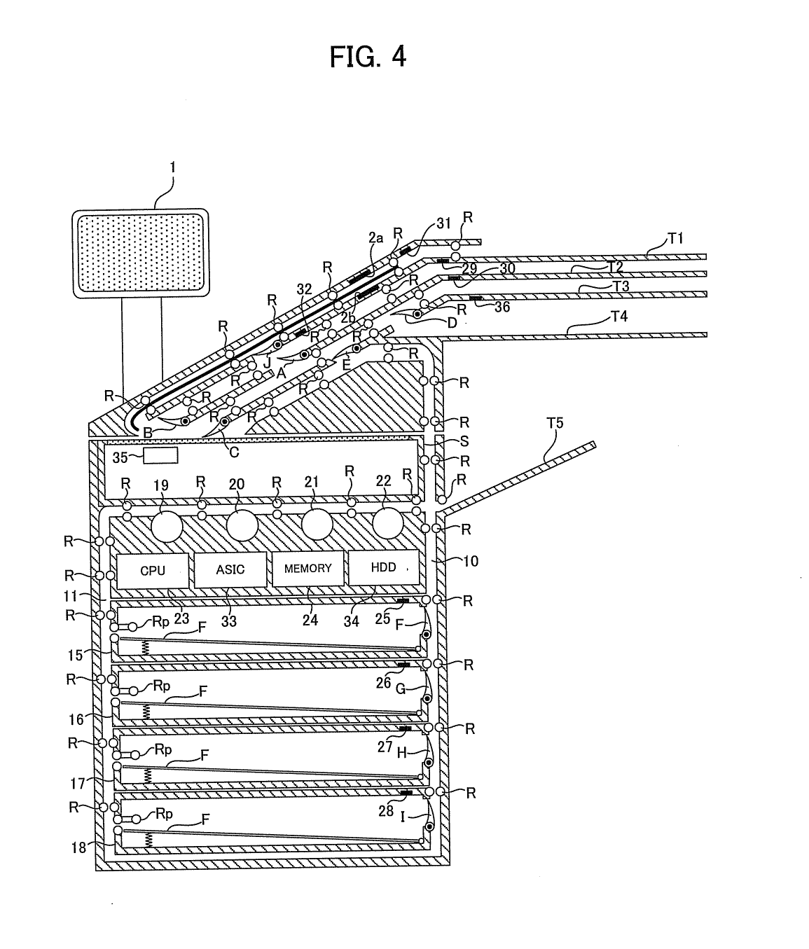

Subsequently, the CPU 701 transports the sheet to a predetermined image reading position using the image reading unit S (states shown in FIGS. 4, 5, and 6), and causes the reading head 35 to scan the sheet surface. At this time, the CPU 701 turns the flapper B on the ADF side upward, and turns the flapper C on the ADF side downward.

The CPU 701 obtains image data which is read from the sheet using the reading head 35 (function as the read image obtaining unit 101), and confirms whether or not the color of the image on the sheet as a target of image reading is appropriately erased using heat processing in the erasing units 2a and 2b, and can be reused (ACT 103) (function as the reuse determination unit 102)

Naturally, it is also possible to set the surface to be determined to be the reusable surface, or not by the CPU 701 to any of the single surface of the sheet, or both surfaces of the sheet. In addition, according to setting by a user, it is also possible not to perform the image reading of the sheet by the image reading unit S.

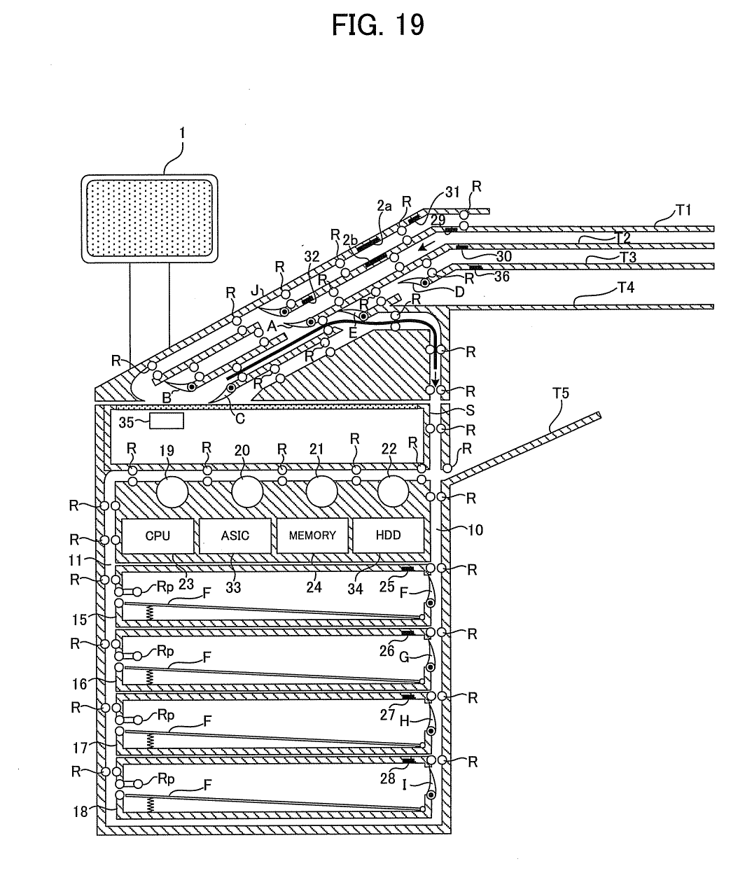

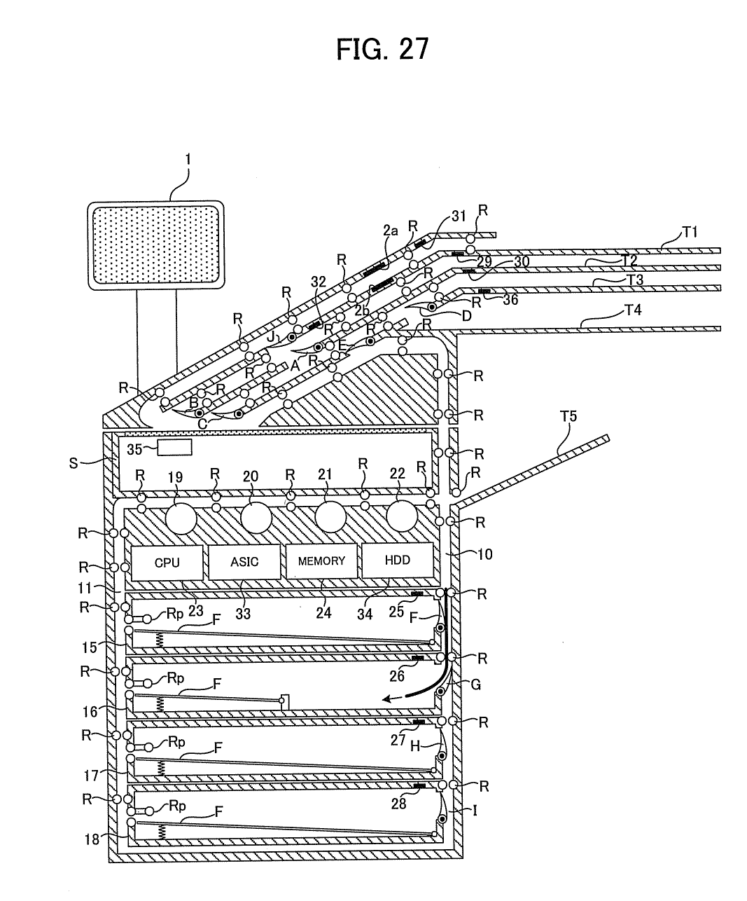

The CPU 701 turns the flapper E on the ADF side upward when it is determined that the color of image on the sheet is appropriately erased, and is reusable (YES in ACT 104), turns the flapper F on the main body side to the left, turns the flapper G on the main body side to the right, and carries the sheet into the supply tray 16 on the main body side of the automatic document feeder 901 (states shown in FIGS. 19 and 27) (ACT 105).

The CPU 701 determines that the number of remaining sheets which is accommodated in the supply tray 16 on the main body side is increased by one, and displays the fact on a display screen (FIG. 36) (ACT 107), when carrying-in of the sheet to the supply tray 16 on the main body side is detected in a carrying-in detection sensor 26 (ACT 106).

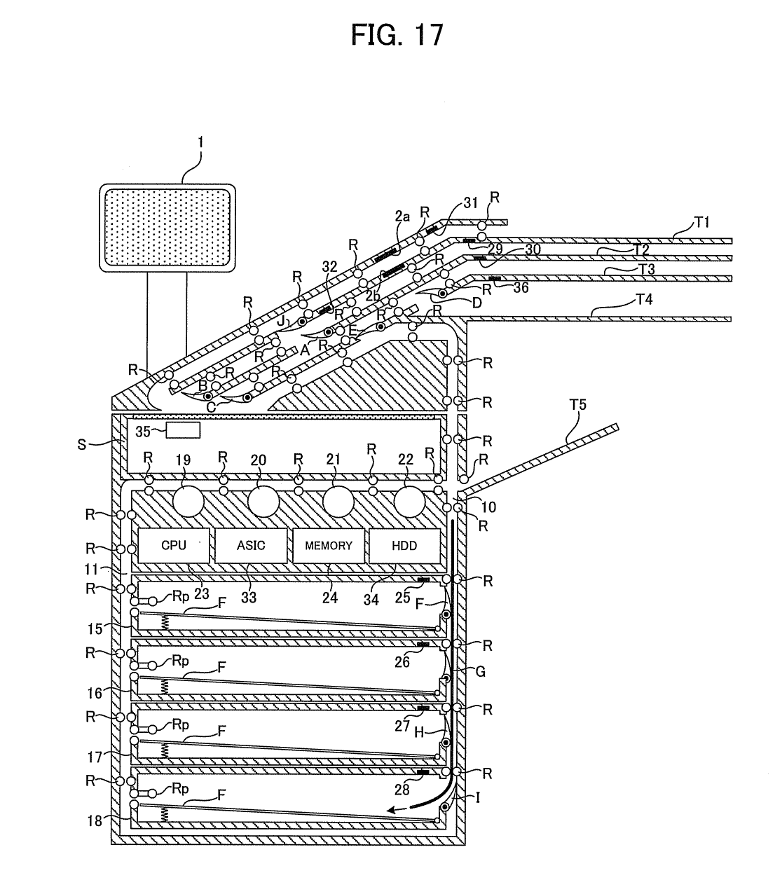

On the other hand, when it is determined that the color of the image on the sheet is not appropriately erased, and is not reusable (NO in ACT 104), the CPU 701 turns the flapper E on the ADF side upward, turns the flappers F to H on the main body side to the left, turn the flapper I on the main body side to the right, and carries the sheet into the supply tray 18 on the main body side of the image forming apparatus 902 (a state shown in FIG. 17) (ACT 108).

When carrying-in of the sheet to the supply tray 18 on the main body side (tray 4) is detected in the carrying-in detection sensor 28 (ACT 109), the CPU 701 determines that the number of remaining sheets which are accommodated in the supply tray 18 on the main body side is increased by one, and displays the fact on the display screen (FIG. 36) (ACT 109).

Subsequently, a case where the sheets are divided and transported using only a mechanism included in the automatic document feeder 901 will be described.

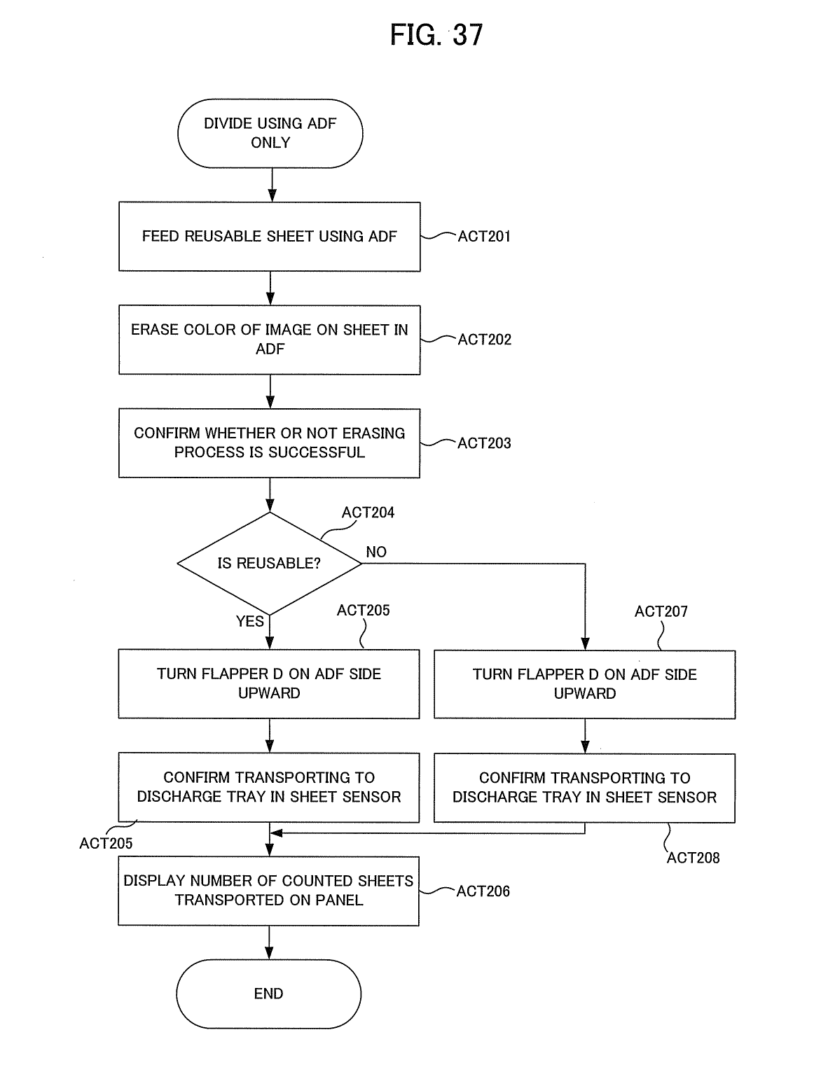

FIG. 37 is a flowchart which illustrates flow of processing in which the sheets are divided and transported using only the automatic document feeder 901.

In addition, regarding the processes from ACT 201 to ACT 204, since the process are the same as those from ACT 101 to ACT 104 shown in FIG. 35, descriptions thereof will be omitted.

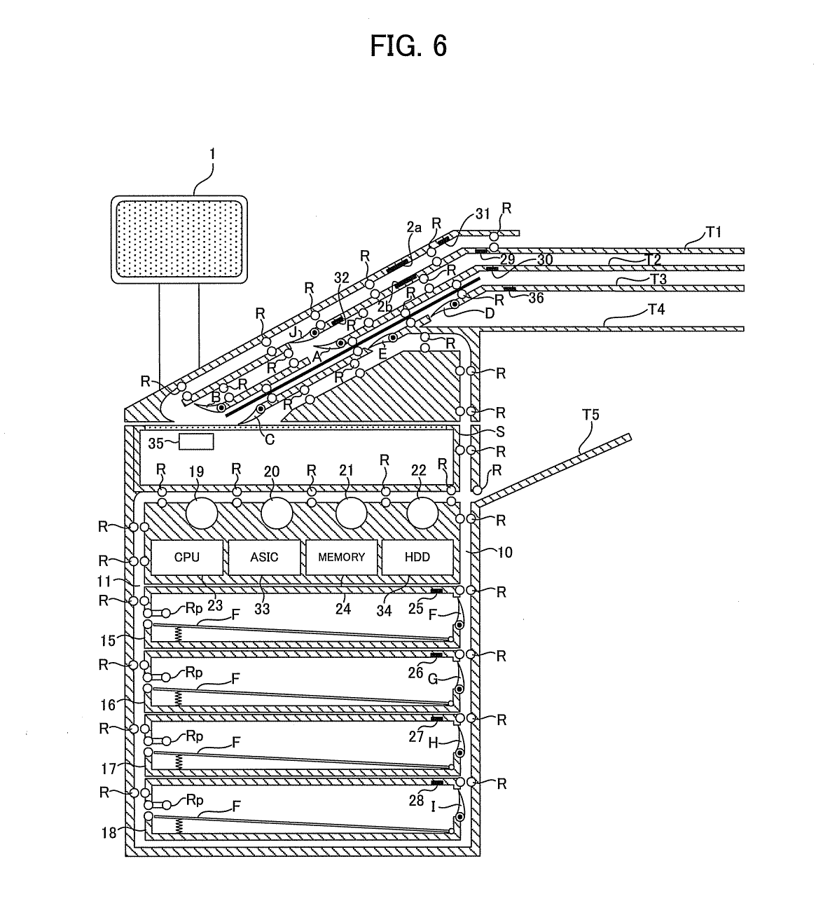

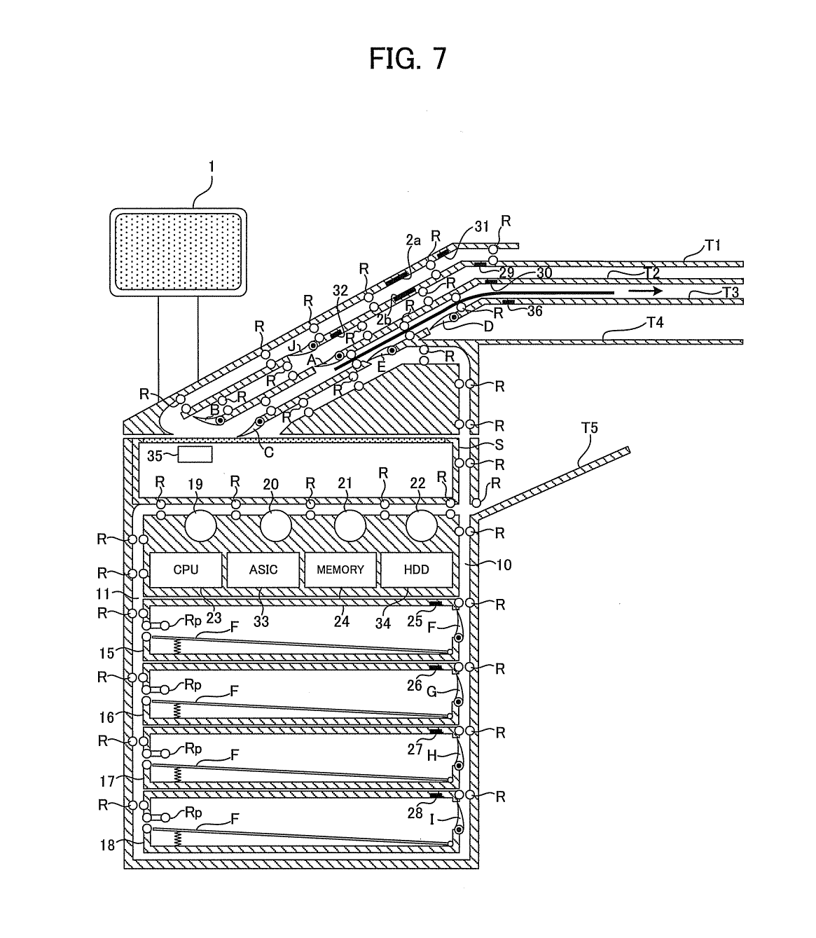

When the color of the image on the sheet is appropriately erased, and is determined to be reusable (YES in ACT 204), the CPU 701 turns the flapper D on the ADF side downward, and discharges the sheet to the discharge tray 3 on the ADF side of the automatic document feeder 901 (a state shown in FIGS. 6 and 7) (ACT 205)

When discharging of the sheet to the discharge tray 3 on the ADF side is detected in the passage detection sensor (ACT 205), the CPU 701 determines that the number of remaining sheets which are discharged to the discharge tray 3 on the ADF side is increased by one, and displays the fact (the number of transported sheets, the size of sheet, whether the sheet is reusable or to be discarded, or the like) displays on the display screen (FIG. 38) (ACT 206).

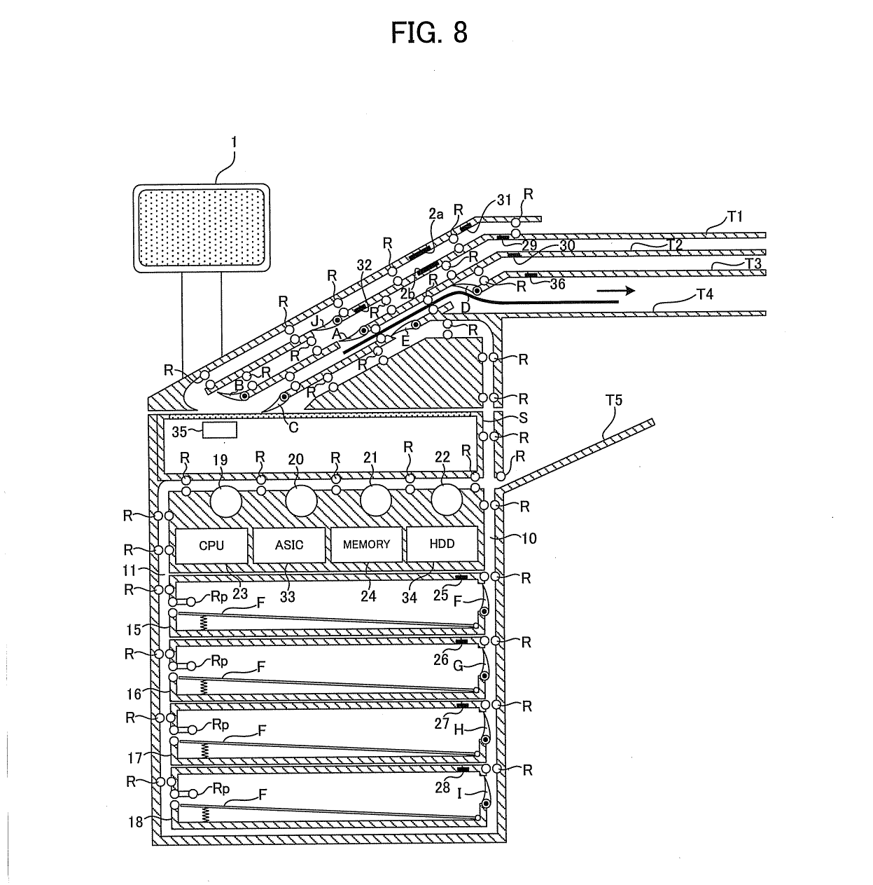

On the other hand, when the color of the image on the sheet is not appropriately erased, and is determined to be unreusable (NO in ACT 204), the CPU 701 turns the flapper D on the ADF side upward, and discharges the sheet to the discharge tray T4 on the ADF side of the automatic document feeder 901 (a state shown in FIG. 8) (ACT 207).

When the discharge of the sheet to the discharge tray T4 on the ADF side is detected in the passage detection sensor (ACT 208), the CPU 701 determines that the number of remaining sheets which are discharged to the discharge tray T4 on the ADF side is increased by one sheet, and displays the fact on the display screen (FIG. 38) (ACT 206).

In addition, when the number of sheets (count value) which is transported to the respective discharge trays T2 to Discharge tray T4 on the ADF side of the automatic document feeder 901 becomes the maximum accommodation number of sheets, the CPU 701 displays a warning on the display screen.

In this manner, in the image forming apparatus according to the embodiment, it is configured such that the sheet which is set in the supply tray T1 of the automatic document feeder 901 can be transported to any of the discharge trays T2 to T4 in the automatic document feeder 901, and the supply trays 15 to 18 on the main body side of image forming apparatus 902.

The CPUs 701 and 23 determine a transport destination of the sheet which is set in the supply tray T1 of the automatic document feeder 901 based on a determination result of the reuse determination unit 102, a sheet size which is detected in each passage sensor, a reading-out result in the image reading unit S, a determination result corresponding to each tray as the transport destination, or the like.

In addition, when the tray which is determined to be the transport destination is already loaded with the maximum accommodation number or more of sheets, the CPUs 701 and 23 set the plurality of discharge trays of the automatic document feeder 901, and a tray with a space in the load capacity in the plurality of supply trays on the main body side of the image forming apparatus are set as the transport destination.

At this time, it is preferable that the tray which is set as the new transport destination be a tray which is correlated with the same determination result as that of the tray as the original transport destination.

In addition, in the image forming apparatus according to the embodiment, it is possible to perform sheet transporting, for example, in the following manner.

(1) When a reuse determination is made only for the single surface of sheets, and the sheets are discharged to the respective plurality of discharge trays on the ADF side, by being divided

In this case, it is not necessary to perform switchback transport of the sheet, and the CPU 701 controls the transport roller R and each flapper so that the sheet is transported in the following flow.

The CPU 701 controls the transport roller R and each flapper so that the sheet is transported in the following flow with respect to the sheet for which the determination result in the reuse determination unit 102 is “reusable”.

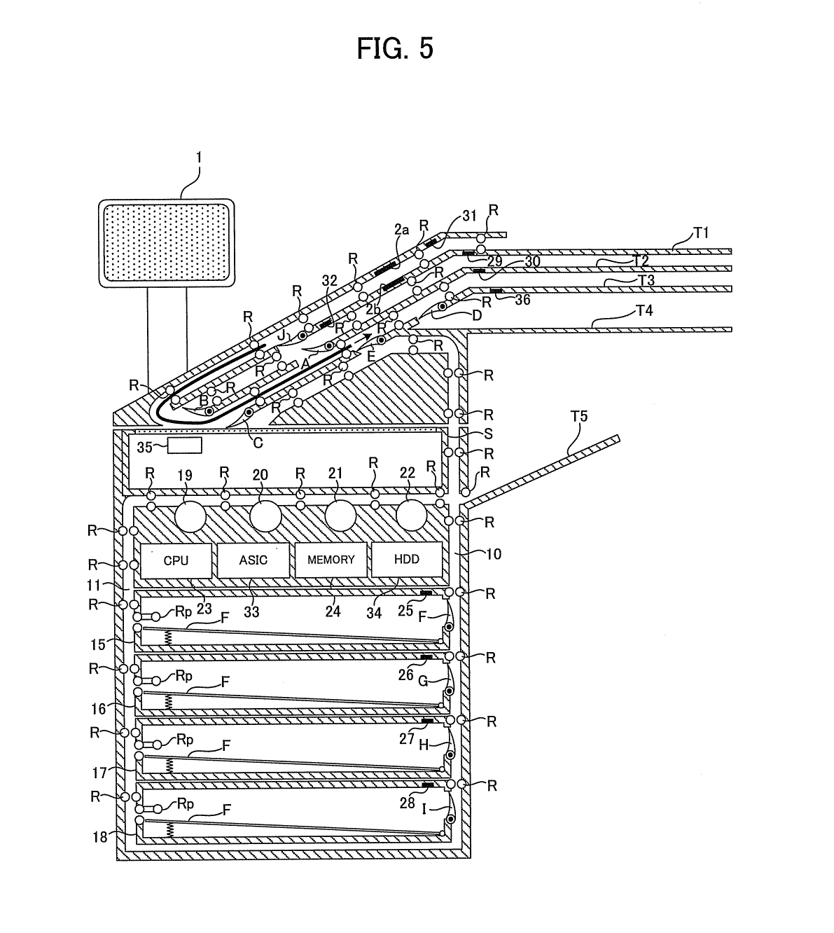

### FIG. 1→FIG. 3→FIG. 4→FIG. 5→FIG. 6→FIG. 7

By performing the sheet transport using the above flow, finally, the CPU 701 discharges the sheet to the discharge tray T3 on the ADF side.

The CPU 701 controls the transport roller R, and each flapper so that the sheet is transported in the following flow with respect to the sheet for which the determination result in the reuse determination unit 102 is “unreusable”.

### FIG. 1→FIG. 3→FIG. 4→FIG. 5→FIG. 6→FIG. 8

By performing the sheet transport using the above flow, finally, the CPU 701 discharges the sheet to the discharge tray T4 on the ADF side.

(2) When the reuse determination is made only for the single surface of sheets, and the sheets are transported to the supply trays on the main body side of image forming apparatus 902, by being divided,

In this case, it is not necessary to perform the switchback transport of the sheet, and the CPU 701 controls the transport roller R, and each flapper so that the sheet is transported in the following flow.

The CPU 701 controls the transport roller R, and each flapper so that the sheet is transported in the following flow with respect to the sheet for which the determination result in the reuse determination unit 102 is “reusable”.

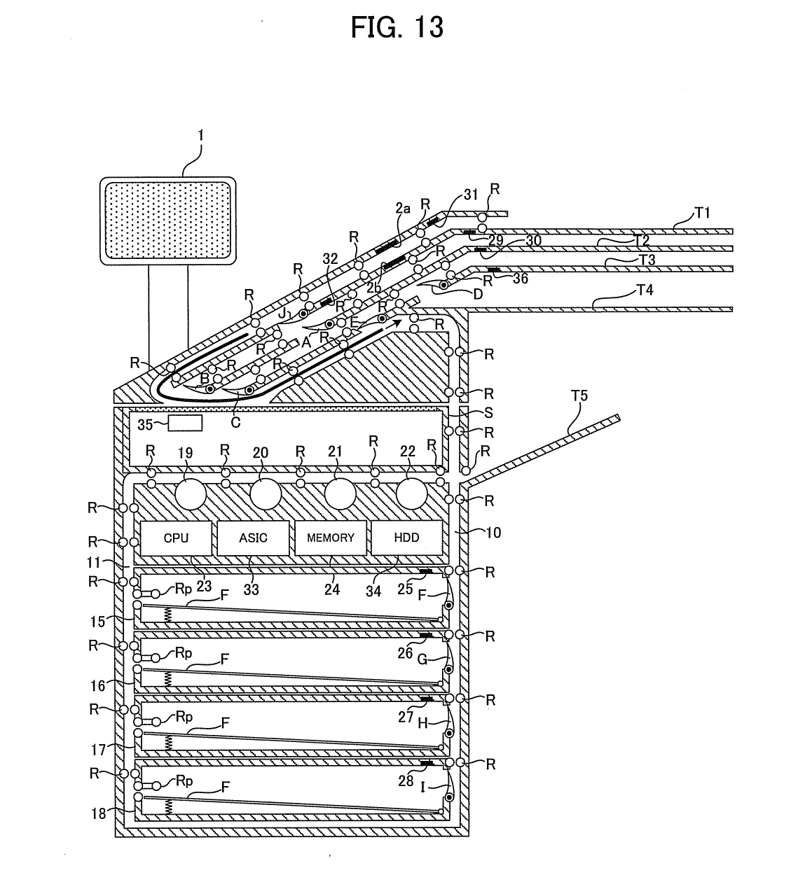

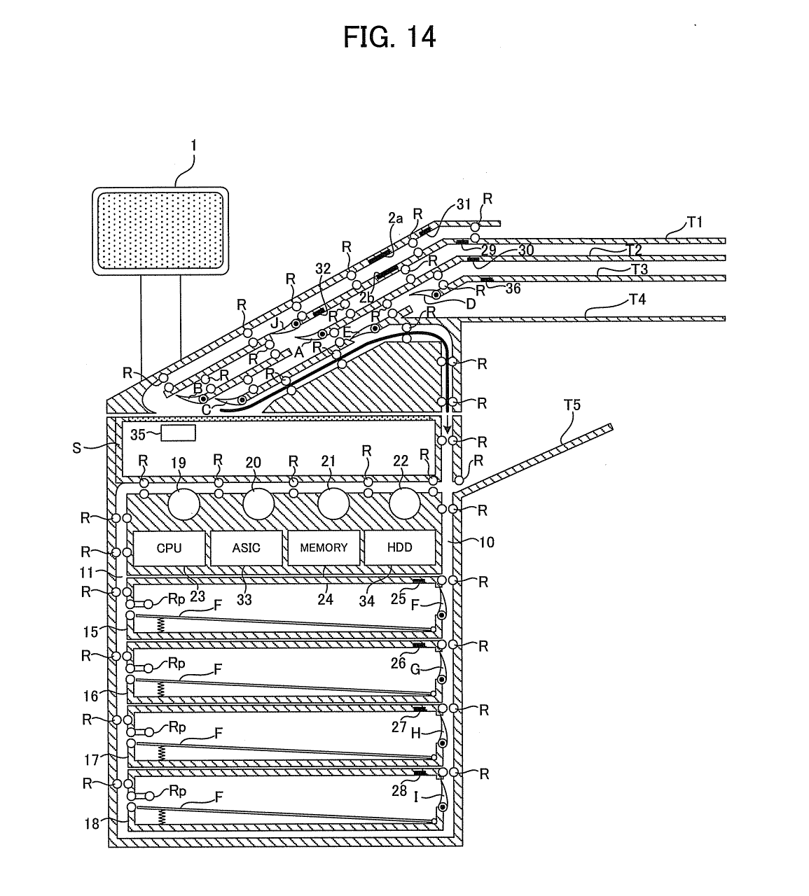

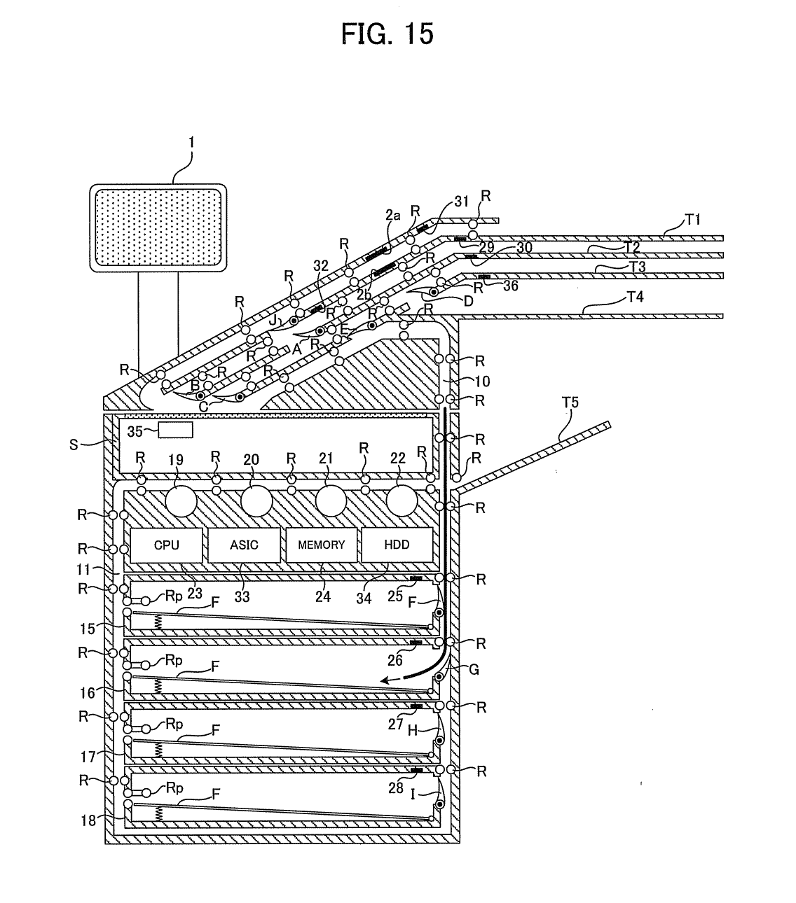

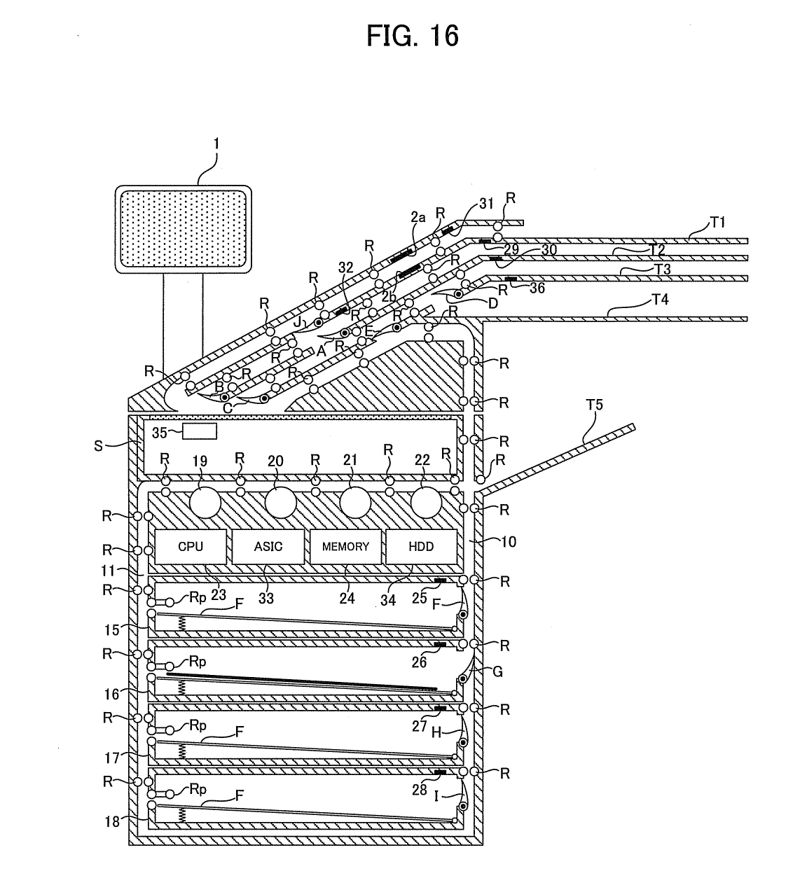

### FIG. 1→FIG. 3→FIG. 13→FIG. 14→FIG. 15→FIG. 16

By performing the sheet transport using the above flow, finally, the CPU 701 discharges the sheet to the discharge tray 16 on the main body side which is set as the transport destination of the reusable sheet in the plurality of supply trays 15 to 18 on the main body side.

The CPU 701 controls the transport roller R, and each flapper so that the sheet is transported in the following flow with respect to the sheet for which the determination result in the reuse determination unit 102 is “unreusable”.

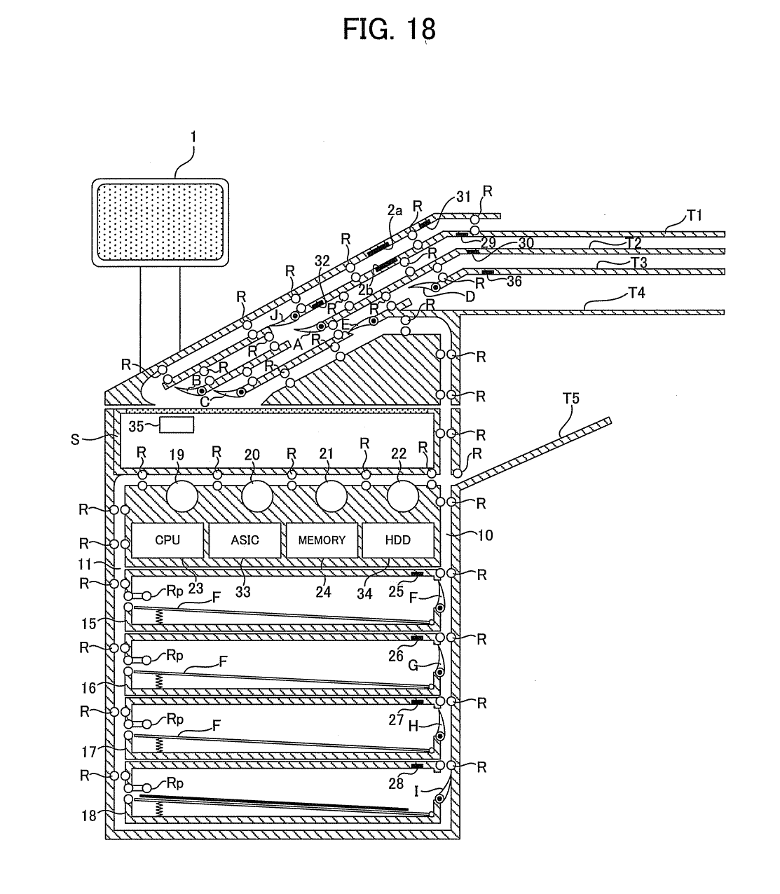

### FIG. 1→FIG. 3→FIG. 13→FIG. 14→FIG. 17→FIG. 18

By performing the sheet transport using the above flow, finally, the CPU 701 discharges the sheet to the discharge tray 18 on the main body side which is set as an accommodation destination of the sheet to be discarded which is unusable in the plurality of supply trays 15 to 18 on the main body side.

(3) When the reuse determination is made with respect to both surfaces of sheets, and the sheets are transported to the respective plurality of discharge trays on the ADF side of the automatic document feeder 901, by being divided,

In this case, it is not necessary to perform the switchback transport of the sheet, and the CPU 701 controls the transport roller R, and each flapper so that the sheet is transported in the following flow.

The CPU 701 controls the transport roller R, and each flapper so that the sheet is transported in the following flow with respect to the sheet for which the determination result in the reuse determination unit 102 is “reusable”.

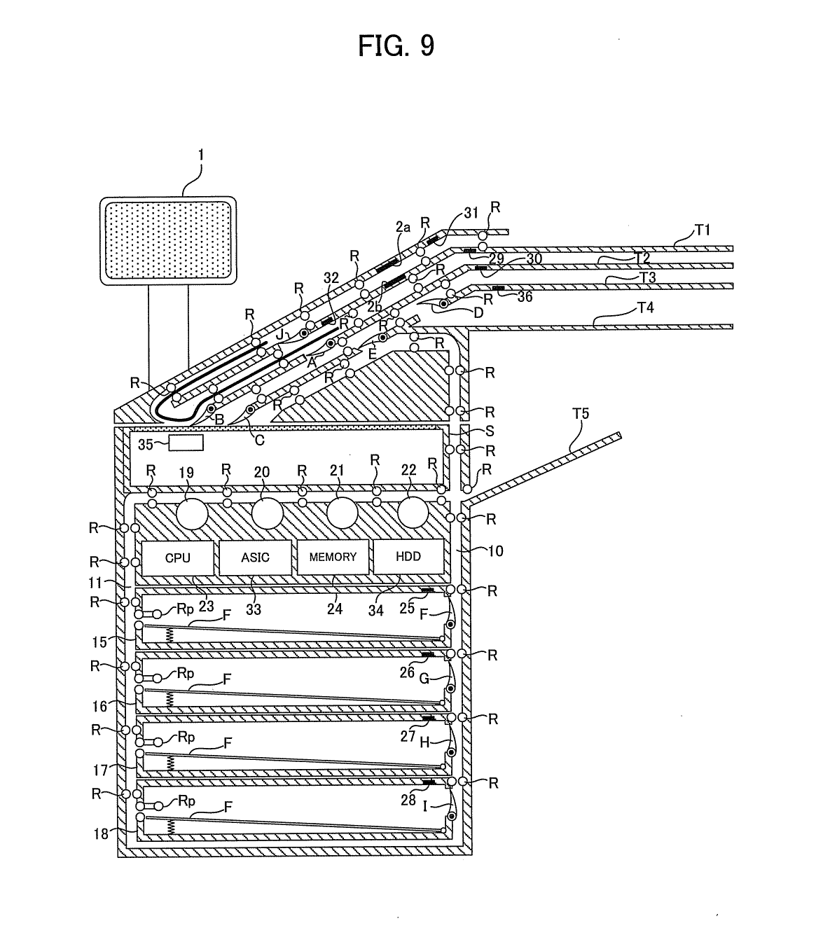

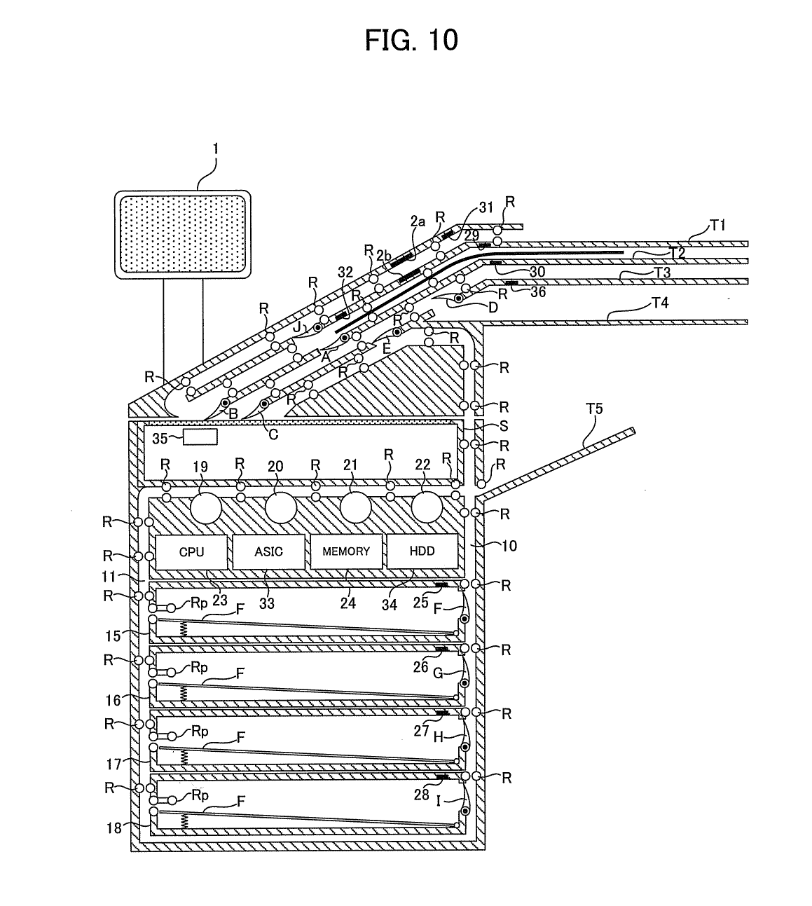

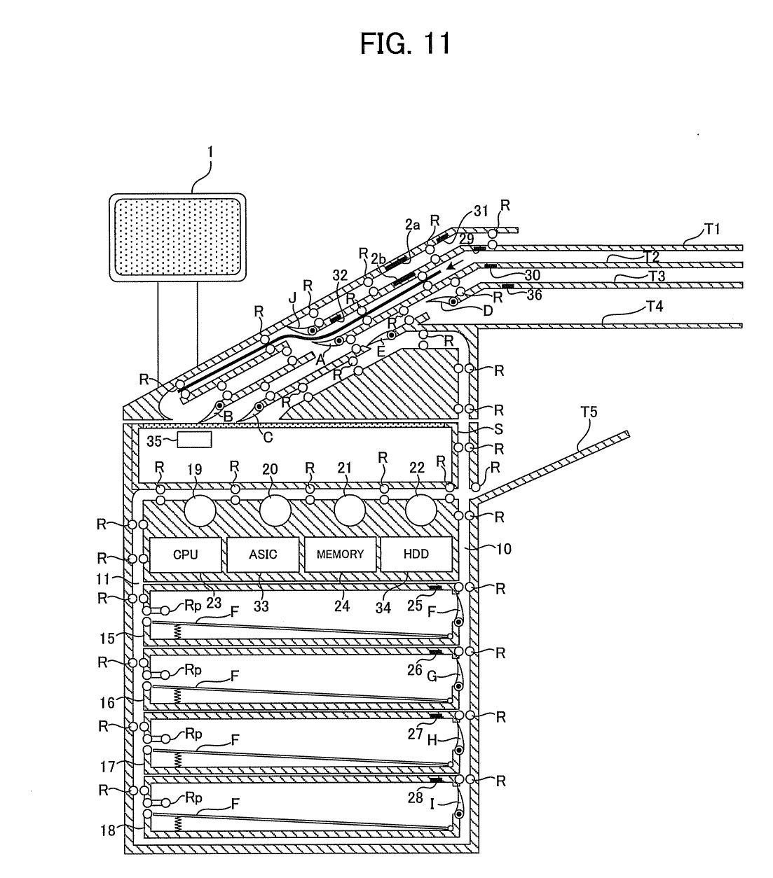

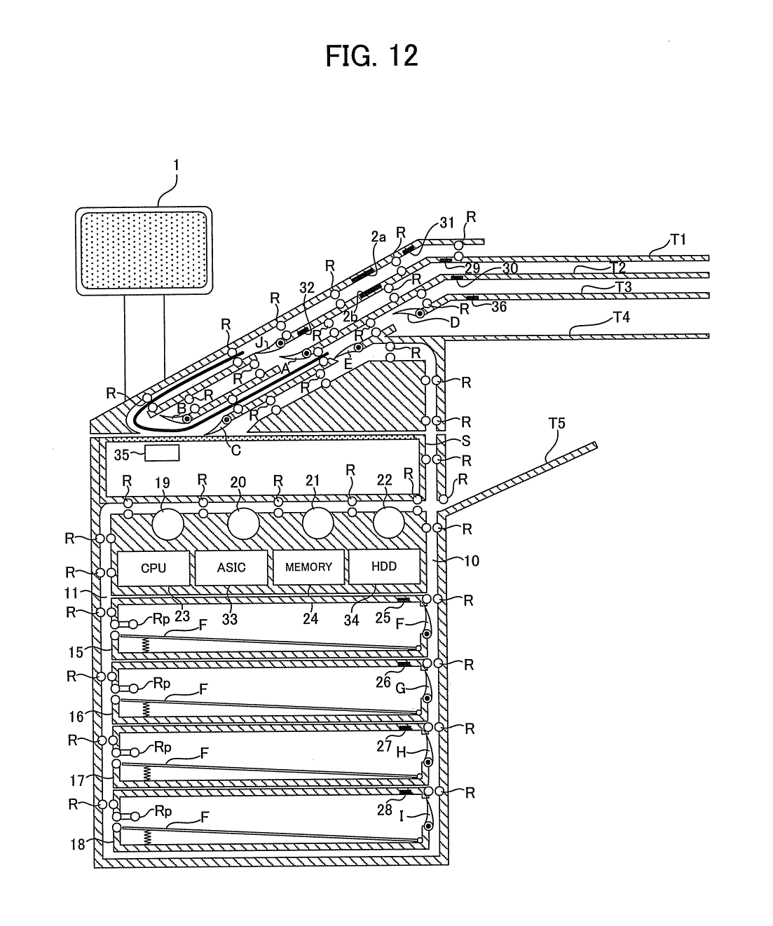

### FIG. 1→FIG. 3→FIG. 9→FIG. 10→FIG. 11→FIG. 12→FIG. 6→FIG. 7

By performing the sheet transport using the above flow, finally, the sheet is discharged to the discharge tray T3 on the ADF side.

The CPU 701 controls the transport roller R, and each flapper so that the sheet is transported in the following flow with respect to the sheet for which the determination result in the reuse determination unit 102 is “unreusable”.

### FIG. 1→FIG. 3→FIG. 9→FIG. 10→FIG. 11→FIG. 12→FIG. 6→FIG. 8

By performing the sheet transport using the above flow, finally, the CPU 701 discharges the sheet to the discharge tray T4 on the ADF side.

In FIG. 10, the CPU 701 turns the flappers A and J on the ADF side upward, performs back feeding of the sheet using the transport roller R, and performs scanning of the rear surface of the sheet by returning the sheet to the transport path of the uppermost part again when the terminal end of the sheet passing through the flapper C on the ADF side is detected by the passage sensor 32 (FIG. 11).

(4) When the reuse determination is made with respect to only the single surface of sheets, and the sheets are transported to the plurality of discharge trays T2 to T4 on the ADF side of the automatic document feeder 901, and the plurality of supply trays 15 to 18 on the main body side of image forming apparatus 902, by being divided,

In this case, it is not necessary to perform the switchback transport of the sheet, and the CPU 701 controls the transport roller R, and each flapper so that the sheet is transported in the following flow.

The CPU 701 controls the transport roller R, and each flapper so that the sheet is transported in the following flow with respect to the sheet for which the determination result in the reuse determination unit 102 is “reusable”.

### FIG. 1→FIG. 3→FIG. 9→FIG. 10→FIG. 11→FIG. 12→FIG. 6→FIG. 7

By performing the sheet transport using the above flow, finally, the CPU 701 discharges the sheet to the discharge tray T3 on the ADF side.

The CPU 701 controls the transport roller R, and each flapper so that the sheet is transported in the following flow with respect to the sheet for which the determination result in the reuse determination unit 102 is “unreusable”.

### FIG. 1→FIG. 3→FIG. 4→FIG. 5→FIG. 19→FIG. 17→FIG. 18

By performing the sheet transport using the above flow, finally, the CPU 701 discharges the sheet to the supply tray 18 on the main body side which is set as the accommodation destination of the sheet to be discarded which is unusable in the plurality of supply trays 15 to 18 on the main body side.

(5) When the reuse determination is made with respect to only the single surface of sheets, and a tray which is correlated with the reusable sheet in the discharge tray on the ADF side of the automatic document feeder 901 is full

In this case, it is not necessary to perform the switchback transport of the sheet, and the CPU 701 controls the transport roller R, and each flapper so that the sheet is transported in the following flow.

In this case, the CPU 701 controls the transport roller R, and each flapper so that the sheet is transported in the following flow with respect to the sheet of which the determination result in the reuse determination unit 102 is “reusable”.

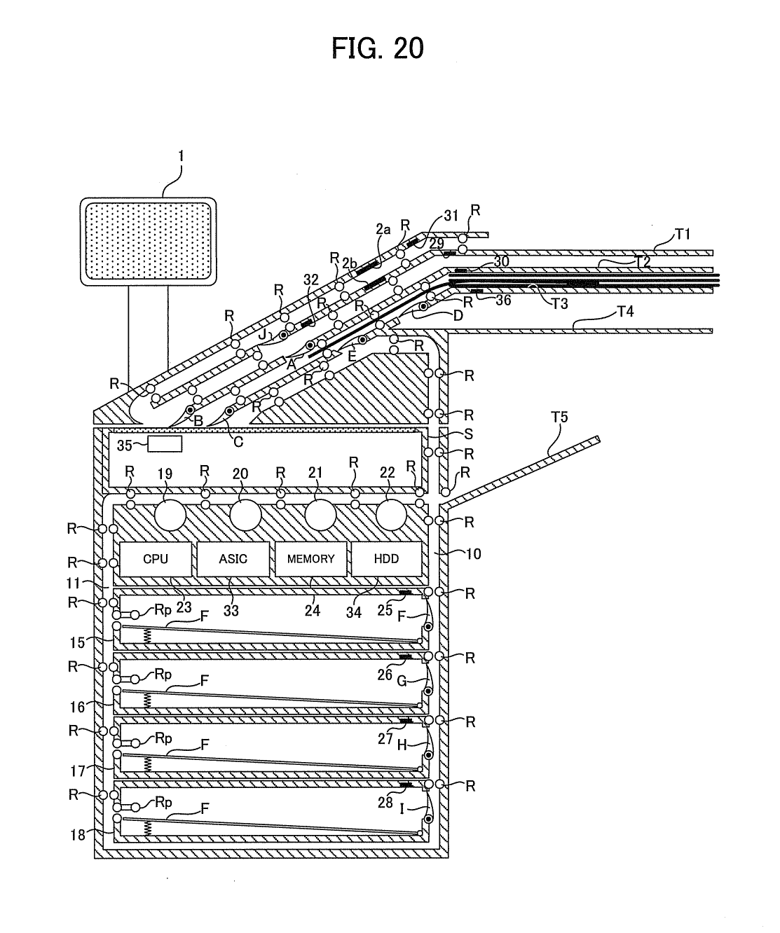

### FIG. 20→FIG. 1→FIG. 3→FIG. 4→FIG. 5→FIG. 19→FIG. 15→FIG. 16

By performing the sheet transport using the above flow, finally, the CPU 701 discharges the sheet to the supply tray 16 on the main body side which is set as the accommodation destination of the sheet to be reused in the plurality of supply trays 15 to 18 on the main body side.

(6) Sheet transporting when performing printing When image forming processing is performed on the sheet using each photoconductive drum of the main body of image forming apparatus 902, the CPU 701 controls the transport roller R, and each flapper so that the sheet is transported in the following flow.

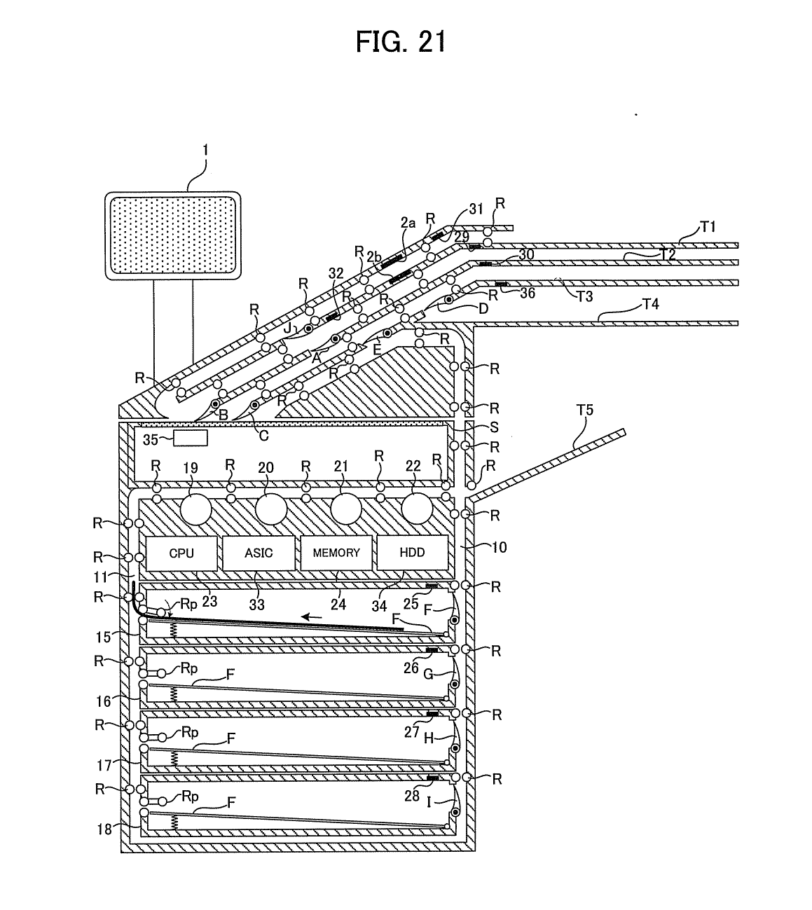

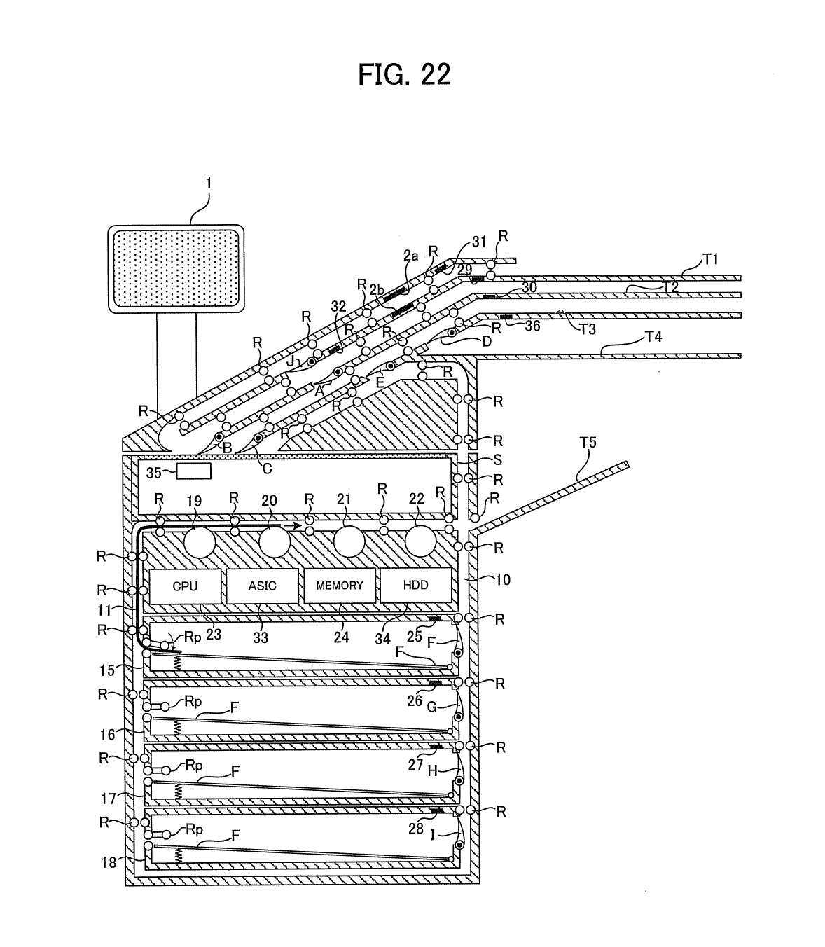

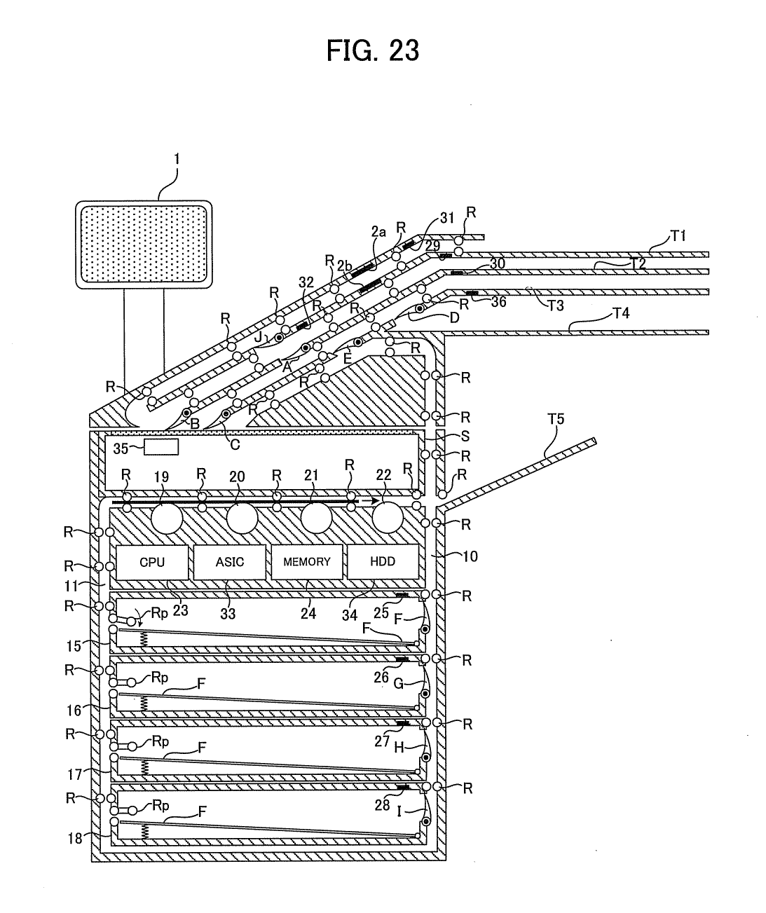

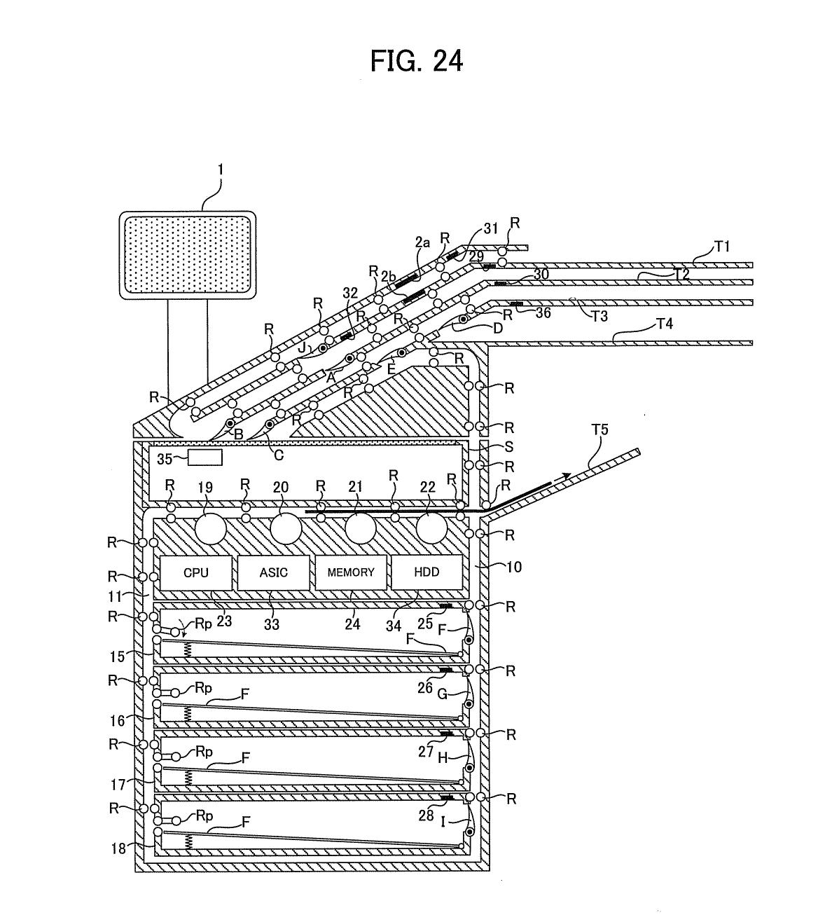

### FIG. 21→FIG. 22→FIG. 23→FIG. 24

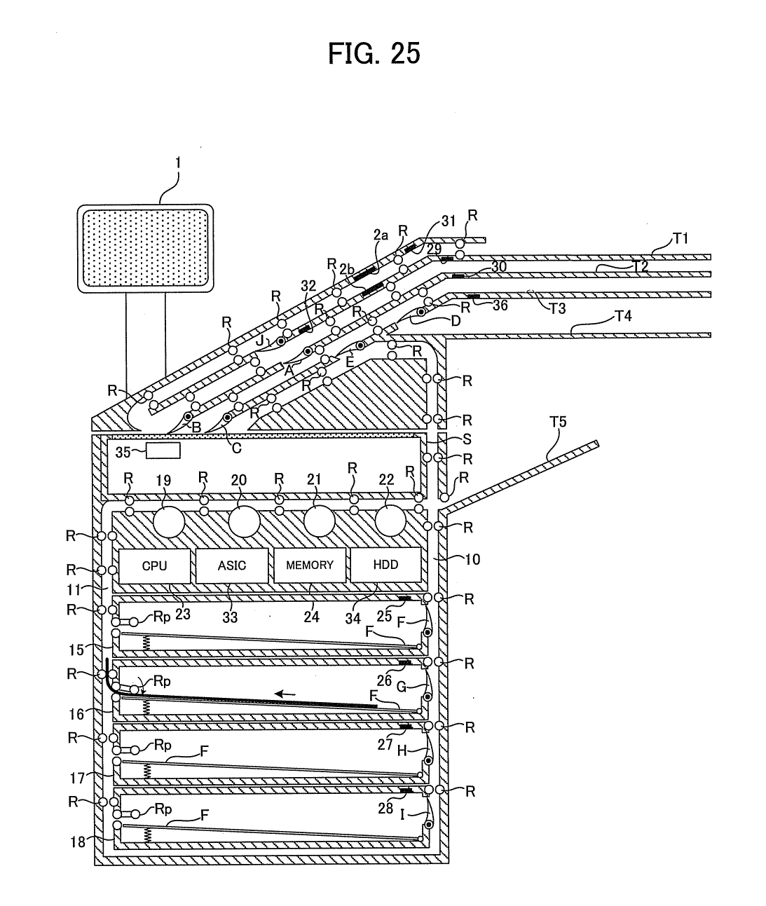

### FIG. 25→FIG. 22→FIG. 23→FIG. 24

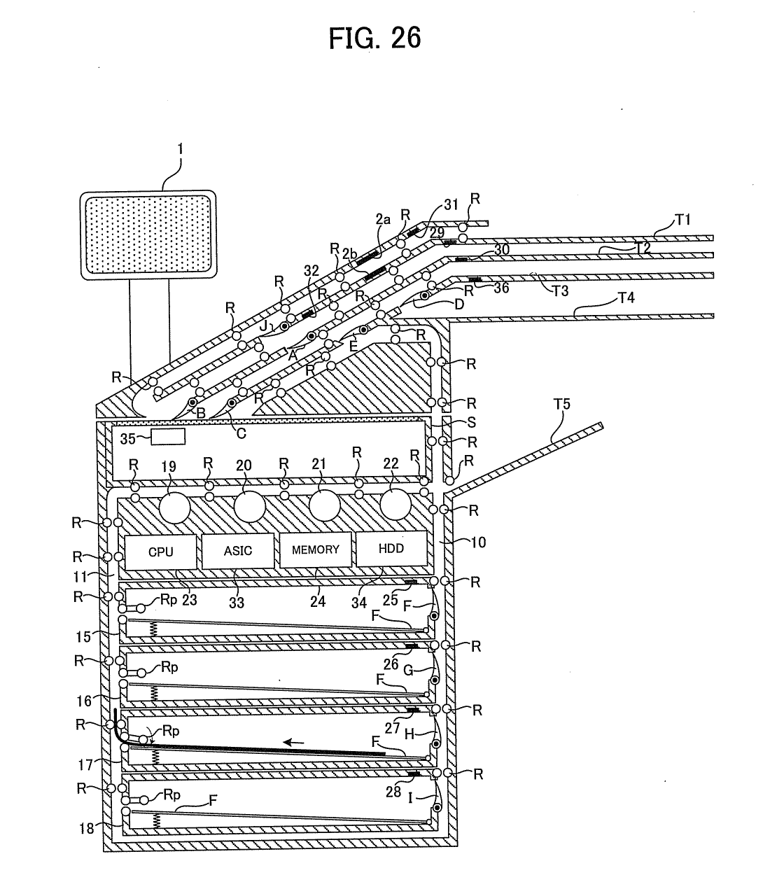

### FIG. 26→FIG. 22→FIG. 23→FIG. 24

That is, when performing the printing, the sheet is transported to the photoconductive drums 19 to 22 through the transport path 10 from any of the plurality of supply trays 15 to 18 on the main body side. After printing, the sheet is discharged to the discharge tray T5 included in the main body of image forming apparatus 902.

(7) When the reuse determination is made only on the single surface of sheets with respect to a reusable sheet of A4 size, and of A3 size using the discharge trays T2 to T4 on the ADF side in the automatic document feeder 901, and then the sheets are discharged by being divided,

In this case, it is not necessary to perform the switchback transport of the sheet, and the CPU 701 controls the transport roller R, and each flapper so that the sheet is transported in the following flow.

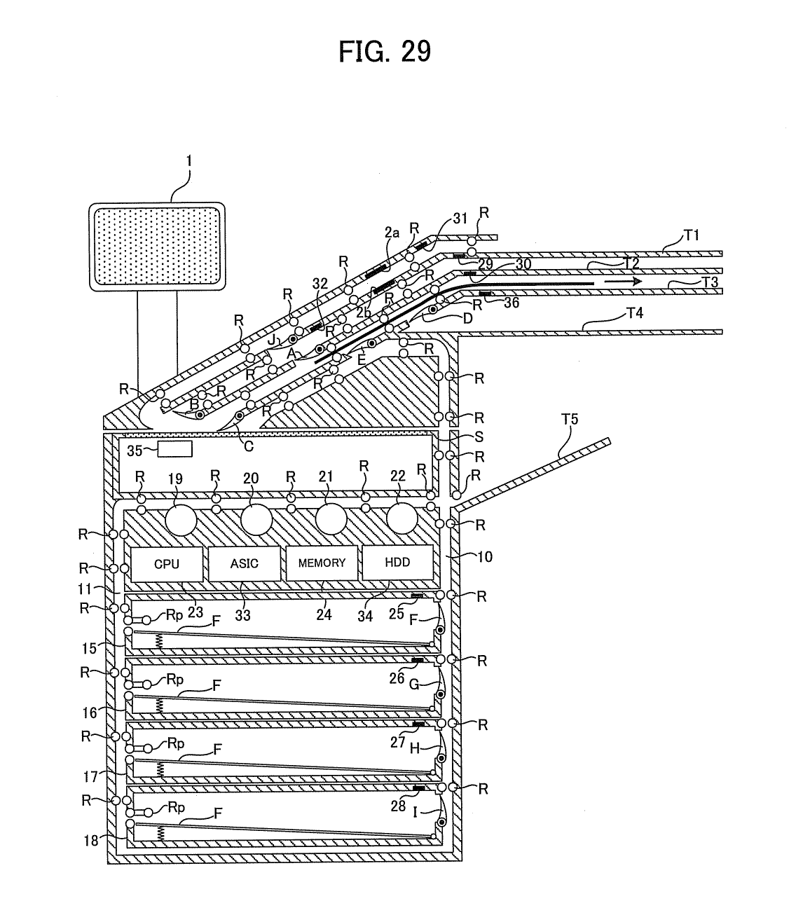

### FIG. 1→FIG. 3→FIG. 4→FIG. 5→FIG. 29

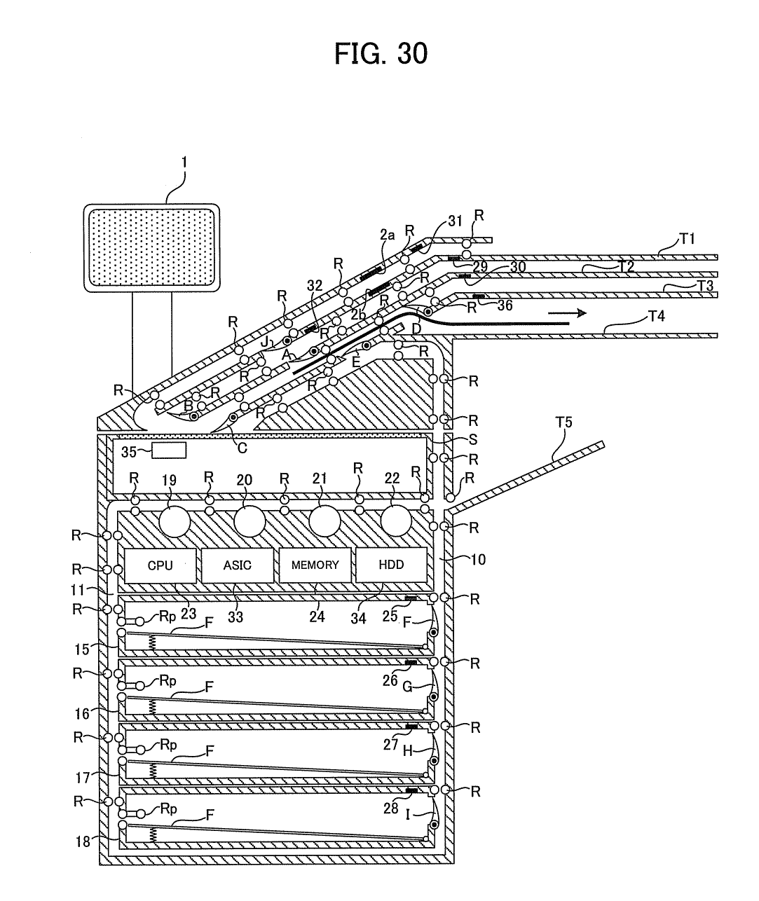

### FIG. 1→FIG. 3→FIG. 4→FIG. 5→FIG. 30

(8) When the reuse determination is made only on the single surface of sheets, and the sheets which are determined to be reused are divided into A4 size, and A3 size, and are transported using the plurality of discharge trays T2 to T4 on the ADF side of the automatic document feeder 901, and the plurality of supply trays 15 to 18 on the main body side of the image forming apparatus 902,

In this case, it is not necessary to perform the switchback transport of the sheet, and the CPU 701 controls the transport roller R, and each flapper so that the sheet is transported in the following flow.

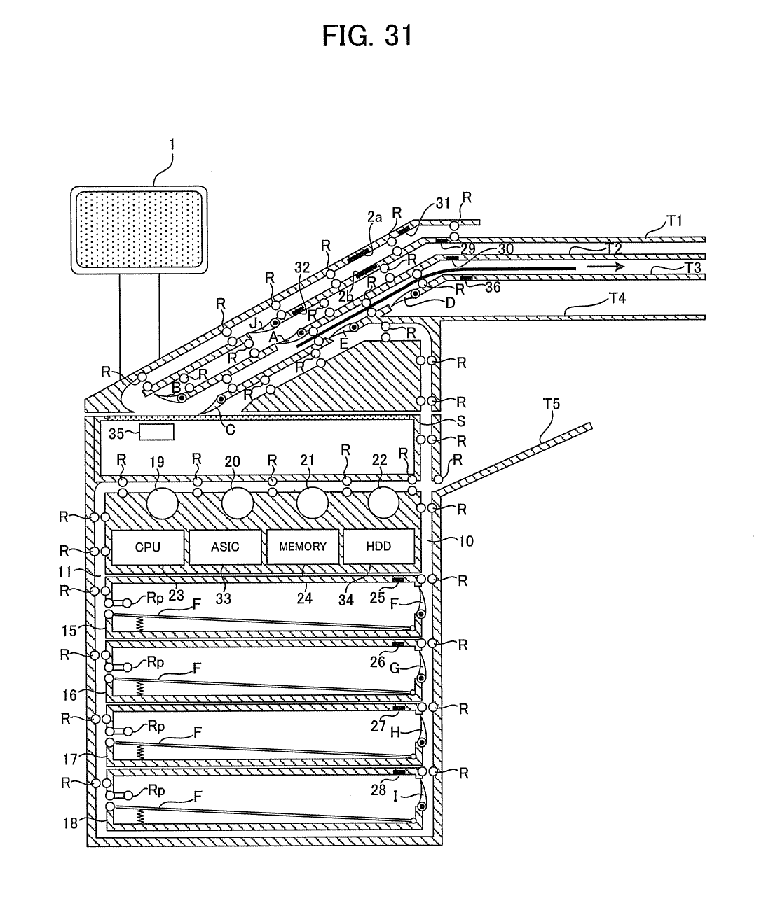

### FIG. 1→FIG. 3→FIG. 4→FIG. 5→FIG. 31

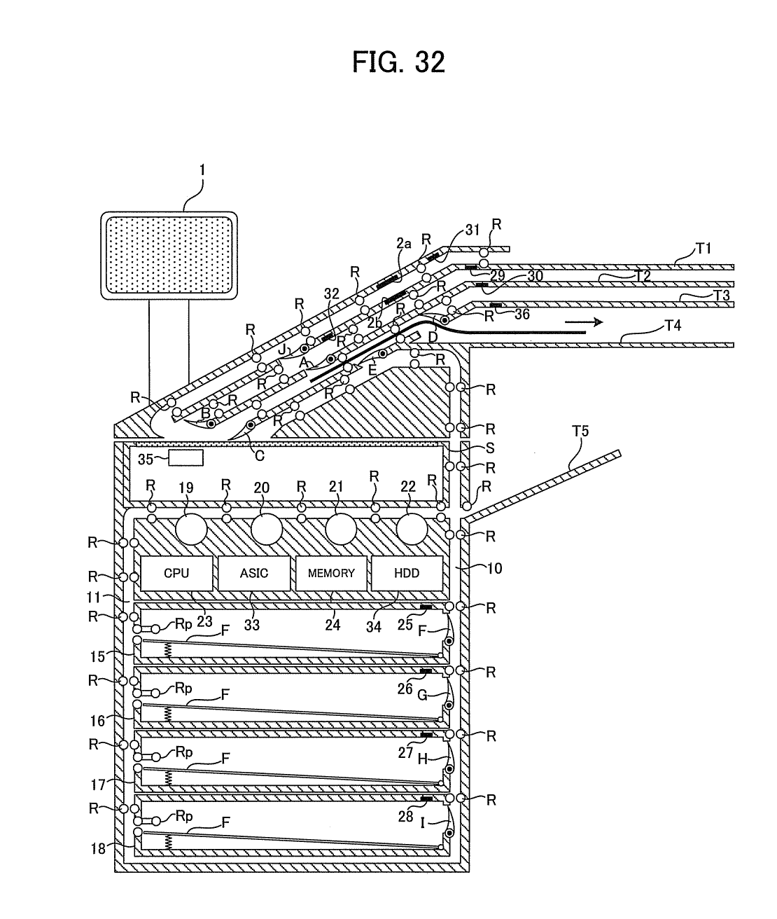

### FIG. 1→FIG. 3→FIG. 4→FIG. 5→FIG. 32

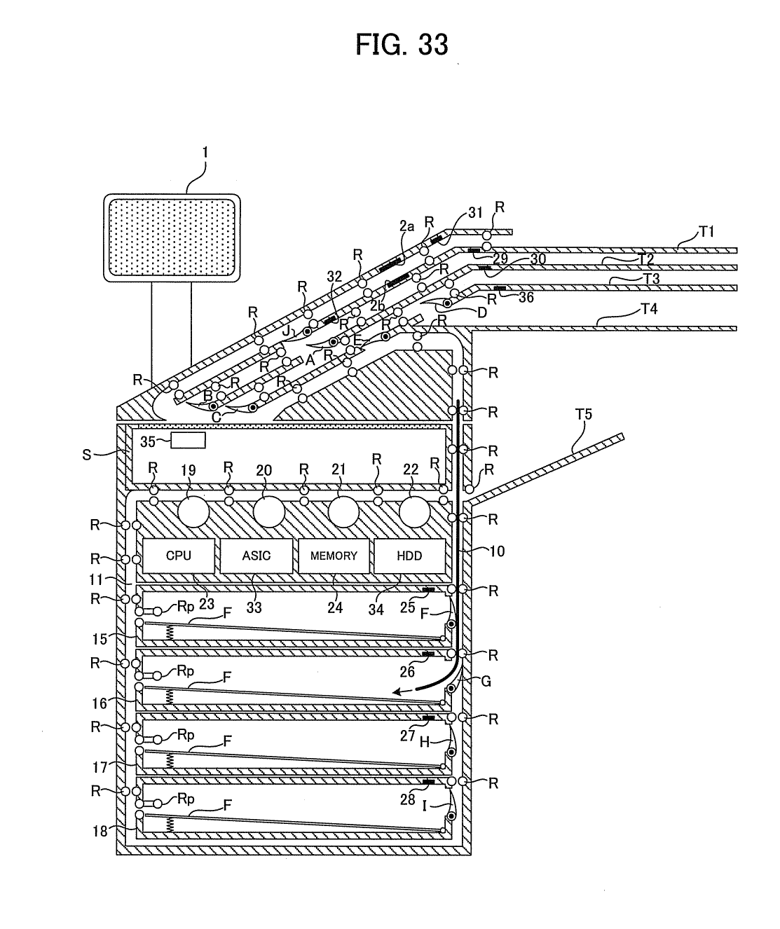

### FIG. 1→FIG. 3→FIG. 4→FIG. 5→FIG. 19→FIG. 33

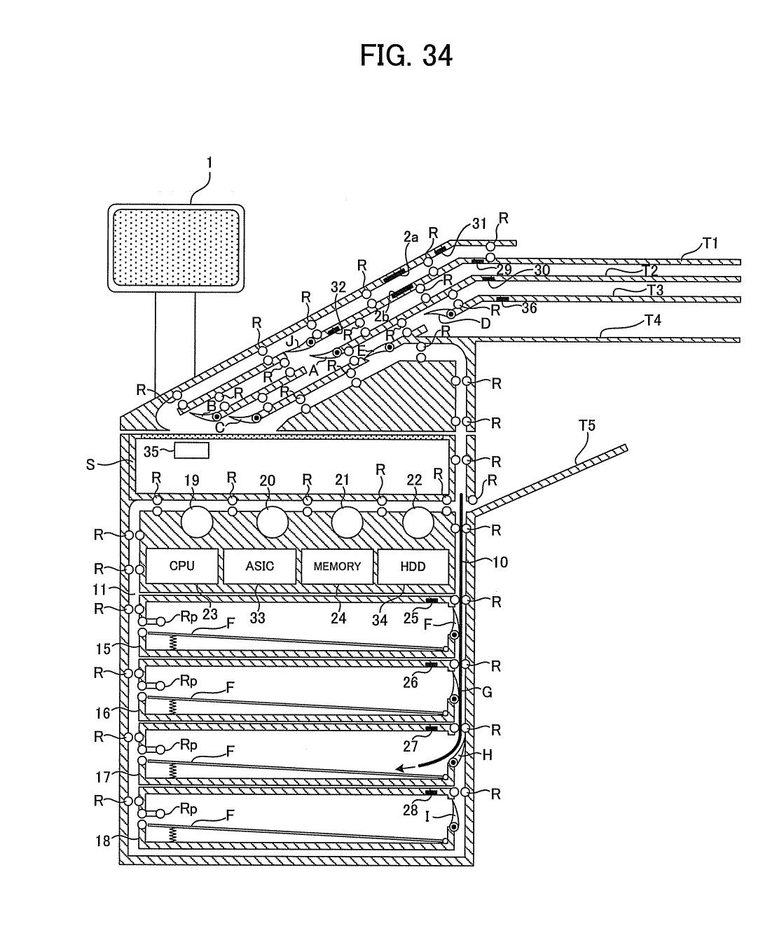

### FIG. 1→FIG. 3→FIG. 4→FIG. 5→FIG. 19→FIG. 34

### <When Performing Copying>

When performing copying, a document which is set in the supply tray T1 of the automatic document feeder 901 is transported, and the document is discharged onto the discharge tray on the ADF side by turning the flapper C on the ADF side downward after being scanned in the image reading unit S.

### <Dividing Processing According to Sheet Size>

In the image forming apparatus according to the embodiment, it is possible to perform a dividing process by dividing the sheet discharge destination according to the size of the sheet which is set in the supply tray T1 of the automatic document feeder 901.

For example, the CPU 701 determines the erasing state, or the size of the sheet by scanning the sheet in the image reading unit S.

Subsequently, by performing the dividing process, for example, when the size of A4 and A3 of the sheets which are set in the supply tray T1 of the automatic document feeder 901 are mixed, the reusable sheet of A3 size is transported to the discharge tray T3 on the ADF side, and the sheet of A3 size is transported to the discharge tray T4 on the ADF side, and the sheet which is determined to be unusable is transported to the tray which is correlated with the sheet to be discarded in the plurality of supply trays on the main body side.

Naturally, it is possible to arbitrarily change the transport destinations of the reusable sheet of A3 size, the reusable sheet of A4 size, and the unreusable sheet when a user operates the touch panel display 1.

In addition, since the sheets which are carried into the supply trays 15 to 18 on the main body side are sequentially loaded onto the sheet bundle which is loaded in advance, a case may be also assumed that only the sheets which are located at the upper part are repeatedly reused with high frequency.

Therefore, a space for receiving sheets is provided at a position in the tray in which the sheets are carried, and the carried-in sheets are received in the space for receiving. In addition, it is preferable that a space for sheets to be carried out be provided at a position from which the sheets are carried out by being picked up using the pickup roller, and the sheets be carried out from a dedicated space for the sheets to be carried out. In this manner, it is possible to avoid deteriorating of only the sheets which are located at the upper part of the sheet bundle which is loaded in the tray by being repeatedly reused.

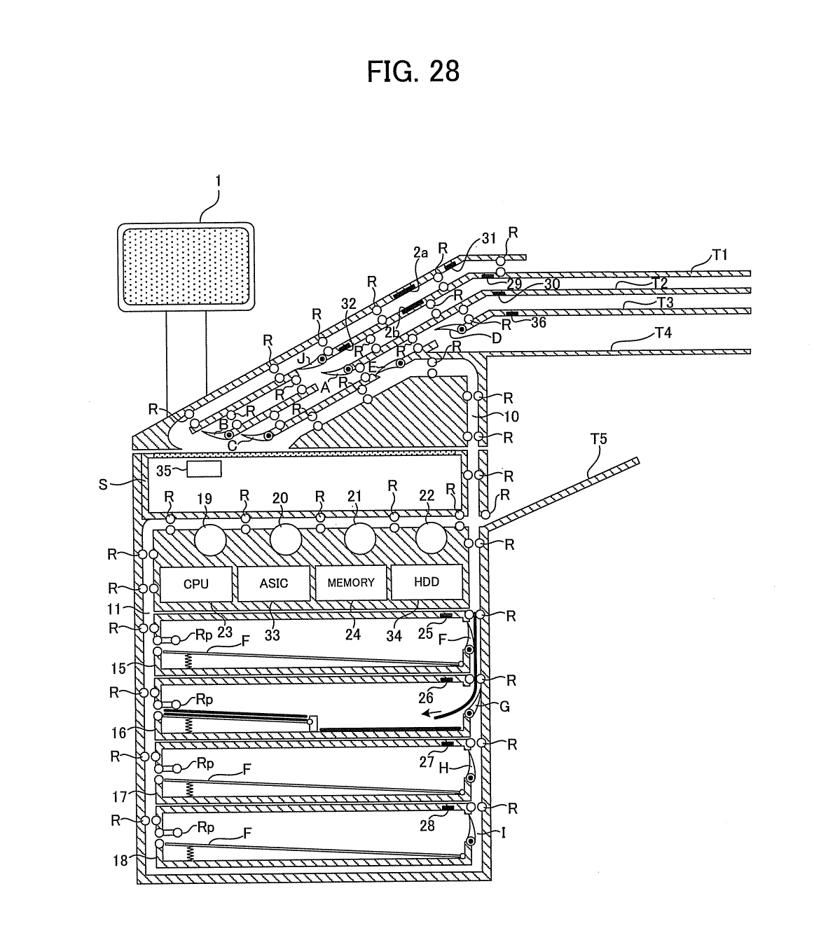

In addition, by establishing a timing for performing the erasing process with respect to the sheet, and transporting the sheet in a lump at a time, the problem of repeatedly reusing only the sheets which are located at the upper part of the sheet bundle loaded in the tray may be avoided. FIGS. 27 and 28 exemplify a configuration in which one tray space is used as two spaces by being divided (the tray as the transport destination and the sheet supply tray).

In addition, in the above described embodiment, it is possible for the CPU 701 to display to which tray the sheet supplied from the supply tray T1 on the ADF side is finally transported on the display 1.

It is possible to determine the number of sheets to be transported based on the detection result using each sensor 25, 26, 27, 28, 29, 30, and 31 which is provided in the tray.

Alternately, as a simple method, it is also possible to count up the trays as the discharge destination based on the number of sheets which is detected in the passage detection sensor 31, and the number of sheets which is determined when performing scanning. When the reuse determination using the scanning is not made, the CPU 701 counts the number of sheets in the tray as the discharge destination which is set in advance.

In addition, according to the embodiment, it is possible to greatly increase the number of sheets as the target of assortment transport by adding the supply tray on the main body side as the transport destination of the assortment transport.

In addition, according to the embodiment, an example of a transport route in which the sheet is guided from the supply tray T1 on the ADF side of the automatic document feeder 901 to a tray as the transport destination is exemplified, however, when physically another transport route can be adopted due to a configuration of the device, it is also possible to perform the sheet transporting using another transport route. That is, it is preferable that the transport route be a route in which the sheet can reach a target transport destination, and a necessary process when transporting the sheet, such as counting the number of necessary sheets, can be performed, as a result.

In addition, it is possible to provide a program in which the above each operation can be executed in the computer configuring the image forming apparatus as a sheet dividing program. According to the embodiment, a case is exemplified in which the program for executing the embodiment is recorded in advance in a storage area which is provided in the apparatus, however, without being limited to this, the same program can be downloaded from a network to the apparatus, or the same program which is stored in a computer-readable recording medium can be installed in the apparatus. As the recording medium, any form is possible, if it is possible to store the program, and is the computer-readable recording medium. Specifically, as the recording medium, for example, there may be an internal storage device which is implemented in a computer such as a ROM, a RAM, or the like, a portable storage medium such as a CD-ROM, a flexible disk, a DVD disk, a magneto-optical disk, an IC card, or the like, a data base which maintains a computer program, or another computer and a data base thereof, a transmission medium on the line, or the like. In addition, functions which are obtained through installing, or downloading in advance in this manner may be executed in cooperation with the OS (operating system), or the like in the apparatus, as well.

In addition, the program may be an execution module a part, or all parts thereof are dynamically generated.

In addition, in each embodiment which is described above, it is natural that at least a part of the various processing executed by executing the sheet dividing program in the CPU 23 can be executed in a circuit manner in the ASIC 33.

As described above, according to the technology which is disclosed in the specification, it is possible to provide a technology of dividing documents in the technology of automatic document feeding in which a plurality of sheet documents is continuously transported toward a predetermined image reading position.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An automatic document feeder comprising:
a supply tray which loads sheets as a transport target;
a transport path which guides the sheets which are loaded in the supply tray to a predetermined plurality of transport destinations, respectively, passing through a predetermined reading position at which an image on each of the sheets is read;
a plurality of flappers which divides the sheets which are transported from the supply tray toward the plurality of transport destinations, respectively;
a plurality of discharge trays which receive the sheets which are divided and transported in the transport path; and
an erasing unit which is provided between the supply tray and the predetermined reading position in the transport path, and erases color of an image which is formed on each of the transported sheets using a decolorable colorant.

2. The feeder according to claim 1,
wherein the erasing unit erases color of the image which is formed using the decolorable colorant using heat, and is provided on the transport path which is located at an uppermost part of the automatic document feeder in the transport path.

3. The feeder according to claim 1,
wherein at least any of the plurality of discharge trays is arranged at a lower part of the supply tray.

4. The feeder according to claim 1, further comprising:
a read image obtaining unit which obtains image data which is read from each of the sheets in the predetermined reading position;
a reuse determination unit which determines whether or not each of the sheets on which an image is read is reusable, on the basis of the image data obtained in the read image obtaining unit; and
a control unit which controls the plurality of flappers so that each of the sheets on which the image is read is guided to a discharge tray which is correlated with the determination result, in advance, among the plurality of discharge trays, based on the determination result from the reuse determination unit.

5. An image forming apparatus comprising:
an automatic document feeder which includes a supply tray which loads sheets as a transport target, a transport path which guides the sheets which are loaded in the supply tray to a predetermined plurality of transport destinations, respectively, passing through a predetermined reading position at which an image on each of the sheets is read, a plurality of flappers which divide the sheets which are transported from the supply tray toward the plurality of transport destinations, respectively, a plurality of discharge trays which receive the sheets which are divided and transported in the transport path, and an erasing unit which is provided between the supply tray and the predetermined reading position in the transport path, and erases color of an image which is formed on each of the transported sheets using a decolorable colorant; and
a main body of the image forming apparatus which includes an image reading unit which reads out an image on the sheet which is transported to the reading position, a printing unit which forms an image on a sheet, a plurality of supply trays on the main body side which supplies a sheet to have an image formed thereon, a transport path on a main body side which guides the sheet which is transported from the automatic document feeder to the plurality of supply trays on the main body side, respectively, and a plurality of flappers on the main body side which divides the sheets which are transported from the automatic document feeder toward the respective plurality of supply trays on the main body side.

6. The apparatus according to claim 5, further comprising:
a read image obtaining unit which obtains image data which is read from each of the sheets in the predetermined reading position;
a reuse determination unit which determines whether or not a sheet on which an image thereon is read is reusable, on the basis of image data which is obtained in the read image obtaining unit; and
a control unit which controls the plurality of flappers on the main body side so that each of the sheets on which the image is read is guided to a discharge tray which is correlated with the determination result, in advance, among the plurality of discharge trays and the plurality of supply trays on the main body side, based on the determination result from the reuse determination unit.

7. The apparatus according to claim 6, further comprising:
a carrying-in detection sensor which detects the number of carrying-in sheets which are carried to the plurality of supply trays on the main body side, respectively,
wherein the control unit on the main body side counts up the number of sheets which is accommodated in the plurality of supply trays on the main body side, respectively, on the basis of a detection result from the carrying-in detection sensor, and the number of carrying-out sheets from the plurality of supply trays on the main body side.

8. The apparatus according to claim 7,
wherein the control unit on the main body side controls the plurality of flappers on the main body side so that sheets are guided to other trays which are correlated with a determination result determined in advance with respect to the sheet among the plurality of discharge trays and the plurality of supply trays on the main body side, when a count value of the accommodation number of sheets in a tray as the sheet transport destination reaches the number of sheets allowed to be accommodated which is set in the tray.

9. The apparatus according to claim 8,
wherein the control unit controls the plurality of flappers so that sheets are guided to any of the plurality of flappers, when all of the supply trays on the main body side which are correlated with the determination result of the sheets reach the number of sheets allowed to be accommodated which is set in the tray.

10. The apparatus according to claim 8,
wherein the control unit controls the plurality of flappers so that sheets which are determined to be reusable are guided to any of the plurality of discharge trays.

11. The apparatus according to claim 8,
wherein the control unit controls the plurality of flappers so that sheets which are determined to be reusable are guided to any of the plurality of discharge trays.

12. A method of dividing sheets in an image forming apparatus which includes
an automatic document feeder including a supply tray which loads the sheets as a transport target, a transport path which guides the sheets which are loaded in the supply tray to a predetermined plurality of transport destinations, respectively, passing through a predetermined reading position at which an image on each of the sheets is read, a plurality of flappers which divide the sheets which are transported from the supply tray toward the plurality of transport destinations, respectively, a plurality of discharge trays which receive the sheets which are divided and transported in the transport path, and an erasing unit which is provided between the supply tray and the predetermined reading position in the transport path, and erases color of an image which is formed on each of the transported sheets using a decolorable colorant; and
a main body of the image forming apparatus including an image reading unit which reads out an image on each of the sheets which are transported to the reading position, a printing unit which forms an image on each of the sheets, a plurality of supply trays on the main body side which supply sheets to have an image formed thereon, a transport path on a main body side which guides sheet which are transported from the automatic document feeder to the plurality of supply trays on the main body side, respectively, and a plurality of flappers on the main body side,
the method comprising:
dividing the sheets which are transported from the automatic document feeder toward the plurality of supply trays on the main body side by the plurality of flappers and the plurality of flappers on the main body side.

13. The method according to claim 12, further comprising:
obtaining image data which is read from each of the sheets at the predetermined reading position;
determining whether or not each of the sheets on which an image is read is reusable based on the obtained image data; and
controlling the plurality of flappers on the main body side so that the each of the sheets on which the image is read is guided to a tray which is correlated with the determination result, in advance, among the plurality of discharge trays and the plurality of supply trays on the main body side, based on the determination result from the reuse determination unit.

14. The method according to claim 13, further comprising:
counting the number of sheets which is accommodated in the plurality of supply trays on the main body side, respectively, on the basis of a detection result from a carrying-in detection sensor for detecting the number of carrying-in sheets to the respective plurality of supply trays on the main body side, and the number of carrying-out sheets from the plurality of supply trays on the main body side.

15. The method according to claim 14, further comprising:
controlling the plurality of flappers on the main body side so that sheets are guided to other trays which are correlated with a determination result determined in advance with respect to the sheets among the plurality of discharge trays and the plurality of supply trays on the main body side, when a count value of the accommodation number of sheets in a tray as the sheet transport destination reaches the number of sheets allowed to be accommodated which is set in the tray.

16. The method according to claim 15, further comprising:
controlling the plurality of flappers so that the sheets are guided to any of the plurality of flappers, when all of the supply trays on the main body side which are correlated with the determination result of the sheet reach the number of sheets allowed to be accommodated which is set in the trays.

17. The method according to claim 15, further comprising:
controlling the plurality of flappers so that a sheet which is determined to be reusable is guided to any of the plurality of discharge trays.

18. The method according to claim 15, further comprising:
controlling the plurality of flappers so that a sheet which is determined to be unreusable is guided to any of the plurality of discharge trays.
